(19) United States
(12) Patent Application Publication
(10) Pub. No.: US 2026/0250871 A1
(43) Pub. Date: Aug. 27, 2026

(54) ELECTRO-SYNTHETIC OR ELECTRO-ENERGY CELLS WITH LIQUID FEATURES

(71) Applicant: Hysata Pty Ltd, Port Kembla, New South Wales (AU)

(72) Inventors: David John COX, Northbridge, New South Wales (AU); Mark Simbajon ROMANO, Kembla Grange, New South Wales (AU); Kristian QUEDDENG, Wollongong, New South Wales (AU); Gerhard Frederick SWIEGERS, North Wollongong, New South Wales (AU); Chong-Yong LEE, Wollongong, New South Wales (AU); Kai Jian YAP, Wollongong, New South Wales (AU)

(21) Appl. No.: 18/854,926

(22) PCT Filed: Apr. 6, 2023
(86) PCT No.: PCT/AU2023/050276

§ 371 Date: Oct. 7, 2024

(30) Foreign Application Priority Data
Apr. 7, 2022 (AU) 2022900916
Apr. 19, 2022 (AU) 2022901037
Dec. 9, 2022 (AU) 2022903764

(51) Int. Cl. C25B 15/08; C25B 9/19; C25B 9/77; C25B 15/02; H01M 8/04276; H01M 8/24; H01M 8/2483

(52) U.S. Cl. CPC C25B 15/08; C25B 9/19; C25B 9/77; C25B 15/02; H01M 8/04283; H01M 8/2459; H01M 8/2483

(57) ABSTRACT

An electro-energy or electro-synthetic cell, including a cathode, an anode and an electrode separator positioned between the cathode and the anode. A liquid electrolyte inlet supplies a liquid electrolyte to the cell, and a liquid electrolyte outlet removes the liquid electrolyte from the cell. The liquid electrolyte outlet includes an overflow weir over or through which excess liquid electrolyte flows out of the cell. In another form, one or more drippers are included as part of the liquid electrolyte inlet and/or the liquid electrolyte outlet and drip chambers are positioned below the drippers. In another form, one or more porous capillary structures are located in liquid pathways in the cell, for example in a liquid pathway provided by an overflow weir or adjacent a dripper. In another form, one or more restrictors are utilised that create a pressure drop in the liquid electrolyte passing through the restrictor.

### TECHNICAL FIELD

The invention broadly relates to electrochemical cells, for example used as electro-synthetic cells or electro-energy cells, that contain liquid. Example embodiments relate to cell architectures that maintain the level of liquid within the cell during operation, whilst simultaneously avoiding unwanted shunt currents.

### BACKGROUND

An electro-energy cell is an electrochemical cell that generates electrical power over sustained periods of time, for use outside of the cell. Electro-energy cells are distinguished from other galvanic cells in that they require a constant external supply of reactants. The products of the electrochemical reaction must also be constantly removed from such cells. Unlike a battery, an electro-energy cell does not store chemical or electrical energy within the electro-energy cell.

Examples of electro-energy cells include but are not limited to Polymer Electrolyte Membrane (PEM) hydrogen-oxygen fuel cells, hydrogen-oxygen alkaline fuel cells, ammonia fuel cells, and the like.

An electro-synthetic cell may be similarly considered to be an electrochemical cell that manufactures one or more chemical materials over sustained periods of time, for use outside of the cell. The chemical materials may be in the form of a gas, liquid, or solid. Like an electro-energy cell, an electro-synthetic cell also requires a constant supply of reactants and a constant removal of products. Electro-synthetic cells may generally further require a constant input of electrical energy.

Examples of electro-synthetic cells include but are not limited to: water electrolyzers, chlor-alkali cells, and cells for manufacturing hydrogen peroxide, ammonia, and the like.

Another feature of electro-synthetic or electro-energy cells is the large quantities of reactants and products that are typically involved in their operation. Such cells need to be constantly fed with substantial amounts of reactants, whilst significant volumes of products must be, simultaneously, constantly removed.

Because of the large quantities of electrical energy involved in operating electro-energy and electro-synthetic cells, a key challenge in their development is to make them as energy efficient as possible during operation. This may be achieved, in part, by minimizing their electrical impedance. Impedance is the opposition that a cell circuit presents to an electrical current when a voltage is applied. One well-known method of minimizing impedance is to employ a cell architecture in which the anode and cathode electrodes of the cell are placed facing each other, as close as possible to each other, without touching (which would create a short circuit). The gap between the two electrodes should then, ideally, also be occupied by an electrolyte having the highest possible conductivity. In general, liquid electrolytes, as a class, have the highest conductivities. The liquid electrolyte may be incorporated within a porous inter-electrode spacer (also called a ‘separator’) whose role is to stop the electrodes from touching one another.

Accordingly, many electro-energy or electro-synthetic cells employ liquid electrolyte, which may be highly conductive, within the cell, or a component half-cell, itself. An important feature of such cells is the need to maintain the quantity of liquid in the cell or half-cell; that is, the need to maintain the level of liquid in the cell or half-cell, to thereby ensure that the level never falls too low or rises too high, which may impede the operation of the cell. Several mechanical or electronic methods exist to detect and then automatically adjust the liquid level within a cell or component half-cell.

A further challenge with electro-energy or electro-synthetic cells of this type is that, in industrial applications, they are often ‘stacked’ in electrical series with multiple other cells to thereby create a ‘cell stack’. This is commonly achieved within a so-called ‘filter-press’ arrangement (or, ‘plate-and-frame filter press’ arrangement). In such an arrangement, individual cells having a substantially flat profile are stacked between two endplates that are then compressed toward each other. This causes the intervening, stacked cells to: (i) make and maintain electrical contact with each other (in electrical series), (ii) be securely held within the stack, and (iii) form a single electro-energy or electro-synthetic device, namely, the filter-press-type cell stack. The cell stack then has the output of all the incorporated cells, as well as their combined consumption. For example, 100 or more cells may be present in a single cell stack. Moreover, the cells may be thin; for example, they may be 1 cm or less in thickness. Additionally, the cells may contain highly corrosive electrolytes, such as strongly alkaline or acidic electrolytes. If the individual cells are held securely in the filter-press arrangement, then the cell stack can be treated as a single device, with the products it generates and the reactants it consumes dealt with by only a few, suitable, external systems. In this way, it potentially becomes possible to accumulate the large quantities of reactants and products involved in electro-energy or electro-synthetic cells into single, external product and/or reactant streams, that are more easily managed than multiple smaller streams.

A further challenge is that the body or bodies of liquid electrolyte within each cell or half-cell in such a stack may be connected to each other. That is, there may be a continuous or contiguous body of common liquid electrolyte that is present in all or many of the cells. In such a case, unwanted ‘shunt’ currents (also called ‘bypass’ currents or ‘parasitic’ currents) can occur. Shunt currents typically flow between electrodes in different cells within the stack. They are often driven by a voltage difference that is larger than the voltage difference between the two electrodes in each cell. Shunt currents therefore circumvent and compete with the desired pathway of electrical current, which is between the two electrodes in each cell. Shunt currents may cause a notable loss of efficiency, as well as corrosion and non-uniform cell performance. Shunt currents may also involve a surface, or surfaces within the electrochemical system.

Accordingly, a need exists to address or ameliorate one or more of these problems. For example, a need exists to maintain the quantity of liquid, or level of liquid within electro-energy or electro-synthetic cells or half-cells without complex or otherwise undesirable electronic or mechanical sensing apparatuses, whilst simultaneously avoiding or reducing the presence of shunt currents between cells or half-cells.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

This Summary is provided to introduce a selection of concepts in a simplified form that are further described below in the Detailed Description. This Summary is not intended to identify all of the key features or essential features of the claimed subject matter, nor is it intended to be used to limit the scope of the claimed subject matter.

In various example aspects, embodiments relate to electro-energy or electro-synthetic cells including liquid electrolyte whose level within the cell needs to be controlled. Preferably such embodiments include at least one liquid electrolyte inlet and at least one liquid electrolyte outlet. Preferably, in one embodiment, the at least one liquid electrolyte outlet comprises an overflow weir, which also can be termed an overflow waterfall, an overflow dam, an overflow dike, an overflow levee, an overflow barrier, an overflow cataract, an overflow boom, or an overflow wall, over which excess liquid electrolyte flows. Preferably, the height of the overflow weir (i.e. waterfall, dam, dike, levee, barrier, cataract, boom, or wall) sets the level of the liquid electrolyte in the electro-energy or electro-synthetic cell, for example for the whole cell or for a component half-cell.

In one example aspect, there is provided an electro-energy or electro-synthetic cell, comprising: a cathode and an anode; a liquid electrolyte inlet for supplying a liquid electrolyte to the cell; and a liquid electrolyte outlet for removing the liquid electrolyte from the cell, wherein the liquid electrolyte outlet may comprise an overflow weir over which excess liquid electrolyte flows.

Preferably, the overflow weir over which excess liquid electrolyte flows has a porous capillary structure at, across the mouth of, or located near to the point at which liquid overflows the weir. A ‘porous capillary structure’ is a porous material that employs a capillary action to draw in and hold liquid electrolyte within it. Such a porous capillary structure holds the liquid electrolyte within it with a capillary pressure, thereby facilitating the movement of liquid electrolyte into and through it but hindering the movement and entrainment of gas into and through the porous capillary structure. Preferably, the porous capillary structure prevents gas from above the liquid level in the cell or half-cell from being drawn into and co-mingling with the flow of liquid passing over the overflow weir. Preferably, the liquid passing over the weir flows away as a homogeneous liquid phase with no co-mingled gas. A first porous capillary structure can be positioned at or downstream of a first overflow weir and/or a second porous capillary structure can be positioned at or downstream of a second overflow weir.

In another example aspect, there is provided an electro-energy or electro-synthetic cell, comprising: a cathode and an anode; a liquid electrolyte inlet for supplying a liquid electrolyte to the cell; and a liquid electrolyte outlet for removing the liquid electrolyte from the cell; wherein the liquid electrolyte inlet and/or the liquid electrolyte outlet are in fluid communication with a dripper.

In another example aspect, there is provided an electro-energy or electro-synthetic cell, comprising: a cathode and an anode; a liquid electrolyte inlet for supplying a liquid electrolyte to the cell; and a liquid electrolyte outlet for removing the liquid electrolyte from the cell, the liquid electrolyte outlet comprising an overflow weir over which excess liquid electrolyte flows; wherein the liquid electrolyte inlet and/or the liquid electrolyte outlet are in fluid communication with a dripper.

A ‘dripper’ is a device that reliably and dependably, if not unfailingly, over relatively long periods of time of continuous or continual operation, breaks a liquid stream passing through it into a continuous, consistent, uniform and/or regular stream of drops, droplets, slugs, or other portions of liquid electrolyte, with gas gaps, for example air gaps, between them. Preferably, the gas gaps, for example air gaps, constitute electrically non-conducting voids, i.e. non-conducting gas voids, that, effectively, break the electrical conductivity of an incoming stream of liquid electrolyte that is otherwise electrically conductive along the incoming stream. That is, where the liquid passing through a dripper is an electrically conductive electrolyte, preferably, the liquid electrolyte body on one side of a dripper is not in electrically conductive contact with the liquid electrolyte body of the other side of the dripper due to the dripper reliably and dependably, if not unfailingly, breaking the liquid stream passing through it into a continuous, consistent, uniform and/or regular stream of drops, droplets, slugs, or other portions of liquid electrolyte, with gas gaps, for example air gaps, between them.

In an example aspect, the electrical resistance between the liquid catholyte or the liquid anolyte on one side of the dripper and the liquid catholyte or the liquid anolyte, respectively, on the other side of the dripper is greater than 1Ω, greater than 10Ω, greater than 50Ω, greater than 100Ω, greater than 400Ω, greater than 700Ω, greater than 900Ω, greater than 1 kΩ, greater than 5 kΩ, greater than 10 kΩ, greater than 50 kΩ, greater than 100 kΩ, greater than 1 MΩ, greater than 5 MΩ, greater than 10 MΩ, greater than 50 MΩ, greater than 100 MΩ, or greater than 1,000 MΩ.

In another example aspect, the at least one liquid electrolyte inlet provides a sufficiently large flow of liquid electrolyte into the cell such that the level of the liquid electrolyte within the cell or component half-cell, set by the liquid electrolyte outlet, remains constant, or substantially constant, during operation of the cell.

In another example aspect, the at least one liquid electrolyte inlet into the cell or component half-cell is in fluid communication with at least one ‘dripper’, for breaking the flow of the liquid electrolyte into one or a series of drops, droplets, slugs, or other portions of liquid electrolyte interspersed with gas gaps, for example air gaps, between them. That is, at least one dripper is positioned to be in-line with the liquid electrolyte inlet.

In another example aspect, the at least one liquid electrolyte outlet of the cell or component half-cell includes at least one ‘dripper’, for breaking the flow of liquid electrolyte out of the cell into one or a series of drops, droplets, slugs, or other portions of liquid electrolyte interspersed with gas gaps, for example air gaps, between them. That is, the at least one liquid electrolyte outlet includes at least one dripper. Preferably, the gas gaps, for example air gaps, constitute electrically non-conducting voids, i.e. non-conducting gas voids, that, effectively, break the electrical conductivity of the outgoing stream of liquid electrolyte that is otherwise electrically conductive along the outgoing stream. Preferably, the dripper reliably, and dependably, if not unfailingly, over relatively long periods of time, breaks the liquid stream passing through it into a continuous, consistent, uniform and/or regular stream of drops, droplets, slugs, or other portions of liquid electrolyte, with gas gaps, for example air gaps, between them.

In another example aspect, there is provided an electro-energy or electro-synthetic cell, comprising a cathode half-cell comprising: a cathode; a liquid catholyte inlet section having a liquid catholyte inlet for supplying liquid catholyte to the cathode half-cell; and a liquid catholyte outlet section having a liquid catholyte outlet for removing liquid catholyte from the cathode half-cell. The cell also comprising an anode half-cell comprising: an anode; a liquid anolyte inlet section having a liquid anolyte inlet for supplying liquid anolyte to the anode half-cell; and a liquid anolyte outlet section having a liquid anolyte outlet for removing liquid anolyte from the anode half-cell. An electrode separator is positioned between the cathode and the anode. A dripper is positioned in-line in the liquid catholyte inlet section, the liquid catholyte outlet section, the liquid anolyte inlet section or the liquid anolyte outlet section. The dripper breaks the liquid catholyte or the liquid anolyte into drops, and the drops are received in a drip chamber positioned below the dripper. Preferably, in one example, the drip chamber has a height of less than 50 mm.

In another example aspect, there is provided an electro-energy or electro-synthetic cell, comprising a cathode half-cell comprising: a cathode; a liquid catholyte inlet for supplying liquid catholyte to the cathode half-cell; and a liquid catholyte outlet providing a first overflow weir over which excess liquid catholyte flows out of the cathode half-cell. The first overflow weir is positioned at a first level being higher in the cathode half-cell than the liquid catholyte inlet. The cell also comprising an anode half-cell comprising: an anode; a liquid anolyte inlet for supplying liquid anolyte to the anode half-cell; and a liquid anolyte outlet providing a second overflow weir over which excess liquid anolyte flows out of the anode half-cell. The second overflow weir is positioned at a second level being higher in the anode half-cell than the liquid anolyte inlet. An electrode separator is positioned between the cathode and the anode.

In another example aspect, the broken nature of the flows of liquid electrolyte into and out of the cell cause the liquid electrolyte within the cell or half-cell to be effectively electrically isolated from the liquid electrolyte in adjacent cells or half-cells, or in other parts of the system. Also, the liquid electrolyte within the cell can be electrically isolated from the liquid electrolyte outside of the cell. Preferably, the electrical isolation of the liquid electrolyte in the cell effectively prevents electrodes or surfaces within the cell from participating in shunt currents with electrodes or surfaces in other cells or elsewhere in the system.

In another example aspect, the electrical resistance between the liquid electrolyte inside the cell and liquid electrolyte outside the cell, due to the broken nature of the liquid electrolyte flows into and out of the cell, is greater than 1Ω, greater than 10Ω, greater than 50Ω, greater than 100Ω, greater than 400Ω, greater than 700Ω, greater than 900Ω, greater than 1 kΩ, greater than 5 kΩ, greater than 10 kΩ, greater than 50 kΩ, greater than 100 kΩ, greater than 1 MΩ, greater than 5 MΩ, greater than 10 MΩ, greater than 50 MΩ, greater than 100 MΩ, or greater than 1,000 MΩ.

In another example aspect, the liquid electrolyte inlet section(s) having liquid electrolyte inlet(s), liquid electrolyte outlet section(s) having liquid electrolyte outlet(s) and dripper(s), for breaking the flow of liquid electrolyte into and out of the cell, are miniaturised.

In another example aspect, the liquid electrolyte inlet section, the liquid electrolyte inlet, liquid electrolyte outlet section, and/or the liquid electrolyte outlet of the cell, and the devices associated therewith for breaking the flow of liquid electrolyte into drops, droplets, slugs or other portions of liquid interspersed with air or gas gaps between them (that is the drippers and/or the drip chambers), are miniature in size, having a thickness or a diameter of less than 50 mm, less than 30 mm, less than 20 mm, less than 10 mm, less than 8 mm, less than 6 mm, less than 4 mm, less than 2 mm, less than 1 mm, less than 0.5 mm, or less than 0.25 mm.

In another example aspect, the liquid electrolyte inlet section, the liquid electrolyte inlet, the liquid electrolyte outlet section, and/or the liquid electrolyte outlet of the cell, and the devices associated therewith for breaking the flow of liquid electrolyte into drops, droplets, slugs, or other portions of liquid interspersed with air or gas gaps between them (that is the drippers and/or the drip chambers), incorporate at least one aperture (e.g. at least one small aperture) or a channel that reliably, dependably, if not unfailingly, breaks up the flow into small droplets. Preferably, the at least one aperture or channel has a diameter less than 5 mm, less than 3 mm, less than 2 mm, less than 1 mm, less than 0.8 mm, less than 0.6 mm, less than 0.4 mm, less than 0.2 mm, less than 0.1 mm, less than 0.05 mm, or less than 0.025 mm.

Preferably, the drops, droplets, slugs or other portions of liquid interspersed with gas gaps, for example air gaps, between them, that are created by the at least one dripper in-line with the liquid electrolyte inlet(s) and the at least one dripper in-line with the liquid electrolyte outlet(s) of the cell (that is the drops, droplets or slugs), are small, having a diameter or a thickness of less than 5 mm, less than 3 mm, less than 2 mm, less than 1 mm, less than 0.8 mm, less than 0.6 mm, less than 0.4 mm, less than 0.2 mm, less than 0.1 mm, less than 0.05 mm, or less than 0.025 mm.

In another example aspect, the liquid electrolyte inlet and/or the liquid electrolyte outlet of the cell and the devices associated therewith for breaking the flow of liquid electrolyte (that is the drippers), break up the flow of liquid electrolyte immediately the flow exits the dripper, into one or a series of drops, droplets, slugs, or other portions of liquid electrolyte interspersed with gas gaps, for example air gaps, between them. That is, preferably the flow of liquid in the gas-filled drip chamber below the dripper is non-continuous immediately below the dripper, as one or a series of drops, droplets, slugs, or other portions of liquid electrolyte interspersed with gas gaps, for example air gaps, between them. Preferably, this feature, in combination with the small size of the droplets created by the dripper, enables the height and width of the gas-filled drip chamber below the dripper to be small. Preferably but not exclusively, the dripper channel itself is filled with liquid electrolyte during the dripping action.

Preferably, a drip chamber (e.g. a gas-filled drip chamber) is positioned below the dripper and has a height less than 50 mm, less than 30 mm, less than 20 mm, less than 15 mm, less than 12 mm, less than 10 mm, less than 9 mm, less than 8 mm, less than 7 mm, less than 6 mm, less than 5 mm, or less than 3 mm.

Preferably, the drip chamber (e.g. the gas-filled drip chamber) below the dripper has a diameter or a width of less than 50 mm, less than 30 mm, less than 20 mm, less than 10 mm, less than 8 mm, less than 6 mm, less than 4 mm, less than 2 mm, less than 1 mm, less than 0.5 mm, or less than 0.25 mm.

Preferably, the drip chamber below the dripper is gas-filled and includes a drip chamber gas line that ensures the drip chamber remains filled with gas. Preferably, the gas gaps are provided via the drip chamber gas line. Preferably, the gas in the drip chamber is not an isolated gas of small fixed volume whose pressure fluctuations influence the dripping action.

In another example aspect, the liquid electrolyte inlet and/or the liquid electrolyte outlet of the cell and the devices associated therewith for breaking the flow of liquid electrolyte into drops, droplets, slugs, or other portions of liquid interspersed with air or gas gaps between them (that is the drippers), include, abut, or are co-located at their top, near to a porous capillary structure in the liquid flow stream feeding the dripper. Preferably, the porous capillary structure prevents gas from the gas-filled drip chamber below the dripper from moving up through dripper into the liquid flow stream feeding the dripper.

Preferably, the drops, droplets, slugs, or other portions of liquid electrolyte interspersed with gas gaps, for example air gaps, between them recombine into a homogeneous liquid phase at the bottom of the gas-filled drip chamber below the dripper. Preferably, the liquid in the homogeneous liquid phase at the bottom of the gas-filled drip chamber below the dripper, flows out of the gas-filled drip chamber at its bottom.

Optionally, the gas-filled drip chamber may be configured as a ‘slug chamber’ wherein the drops, droplets, or other portions of liquid interspersed with air or gas gaps between them take the form of slugs of liquid that touch the walls of the slug chamber as they flow through it. Optionally, the slugs may be created by co-mingling of a homogeneous liquid phase flowing out of the dripper and a homogeneous gas phase flowing out of a slug chamber gas line located near the dripper outlet in the slug chamber.

Optionally, a second dripper and associated gas-filled drip chamber or slug chamber, may be incorporated into a liquid pathway above or below a first dripper and associated gas-filled drip chamber or slug chamber, to thereby provide improved electrical isolation.

Optionally, multiple drippers and associated gas-filled drip chambers or slug chambers, may be incorporated into the liquid pathways into or out of the cell.

In another example aspect, the at least one dripper, included in-line with the at least one liquid electrolyte inlet and/or the at least one liquid electrolyte outlet, comprises of a polymeric material. Preferably, the dripper is injection moulded or machined.

In another example aspect, the at least one dripper, included in-line with the at least one liquid electrolyte inlet and/or the at least one liquid electrolyte outlet, contains a metal lined aperture or portion of the aperture. Preferably, the metal is electrically isolated from other metal in the cell and electrically grounded.

In another example aspect, the at least one dripper, included in-line with the at least one liquid electrolyte inlet and/or the at least one liquid electrolyte outlet, is impervious to corrosive liquid electrolyte.

In another example aspect, a further dripper, and a further drip chamber positioned below the further dripper, are provided in fluid communication with the dripper and the drip chamber. Preferably, the further dripper and the further drip chamber are positioned in the liquid catholyte inlet section, the liquid catholyte outlet section, the liquid anolyte inlet section or the liquid anolyte outlet section in-line with the dripper and the drip chamber.

In another example aspect, the liquid electrolyte inlet(s), liquid electrolyte outlet(s) and dripper(s), for breaking the flow of liquid electrolyte into and out of the cell, and/or the overflow weir(s) for maintaining the liquid level within the cell/half-cells, and/or the other liquid features described above, are incorporated into the frame of the cell. Preferably, the liquid pathways are incorporated into the cell frame.

In another example, the liquid electrolyte inlet is an opening or aperture at an end of a liquid electrolyte inlet section. The liquid electrolyte inlet section can be a pipe, conduit, channel or the like. At least one dripper can be positioned in the liquid electrolyte inlet section, for example positioned inside and in-line with the liquid electrolyte inlet section.

In another example, the liquid electrolyte outlet is an opening or aperture at an end of a liquid electrolyte outlet section. The liquid electrolyte outlet section can be a pipe, conduit, channel or the like. At least one dripper can be positioned in the liquid electrolyte outlet section, for example positioned inside and in-line with the liquid electrolyte outlet section.

Preferably, the cell frame comprises a polymer material. Preferably, the cell frame is injection moulded or machined.

In another example aspect, cells incorporating liquid features of the above types are stacked within a cell stack. Preferably, the cell stack is a filter-press type cell stack.

Preferably, the cell frame is essentially flat or, at least, uniformly thick. Preferably, the cell frame is thin. Preferably, the cell frame has a thickness of less than 50 mm, less than 30 mm, less than 20 mm, less than 10 mm, less than 8 mm, less than 6 mm, less than 4 mm, less than 2 mm, less than 1 mm, less than 0.5 mm, or less than 0.25 mm.

Optionally, the liquid pathways in a cell frame may be formed as open sided cavities on a face of the cell frame. Optional, such liquid pathways may be sealed against leakage by affixing a cover over them. Optionally, such liquid pathways may be sealed against leakage by stacking and compressing the cells in a filter-press arrangement.

In another example aspect, the liquid inlet header of the cells within the stack is pressurised to a higher pressure than the liquid in each cell. Preferably, the header is in fluid communication with each cell in the stack. Preferably, the pressure of the outlet header of the cells in the stack is lower than the pressure of the liquid in each cell. Preferably but not exclusively, the liquid passing from a higher to a lower pressure region is first passed through a restrictor prior to passing through a dripper to thereby break up the liquid stream. Preferably but not exclusively, the restrictor creates a pressure drop that has the effect of ensuring that each cell in a cell stack containing more than one cell has an equal or substantially equal quantity of liquid passing into it, out of it, or through it during operation. Preferably, the restrictor is a moulded polymer. Preferably, the restrictor is an injection moulded or machined polymer. Preferably, the restrictor is positioned upstream of a dripper.

Optionally, the cell with the above liquid features is an electro-energy cell, such as: (i) a hydrogen-oxygen fuel cell, including a Polymer Electrolyte Membrane (PEM) fuel cell or an Alkaline fuel cell, (ii) a direct alcohol fuel cell, including a direct methanol or direct ethanol fuel cell, (iii) a phosphoric acid fuel cell, or (iv) an ammonia fuel cell.

Optionally, the cell with the above liquid features is an electro-synthetic cell, such as: (i) a water electrolyser, (ii) a chlor-alkali electrolyzer, (iii) a cell for ammonia manufacture, or (iv) a CO₂ electrolyser, including a combined carbon capture and CO₂ electrolyser.

### BRIEF DESCRIPTION OF THE FIGURES

Illustrative embodiments will now be described solely by way of non-limiting examples and with reference to the accompanying figures. Various example embodiments will be apparent from the following description, given by way of example only, of at least one preferred but non-limiting embodiment, described in connection with the accompanying figures.

FIG. 1 depicts, in schematic form, a cross-section of a preferred example embodiment electro-energy or electro-synthetic cell.

FIG. 2 depicts, in schematic form, a cross-section of the preferred example embodiment electro-energy or electro-synthetic cell in FIG. 1 but fitted with porous capillary structures to prevent entrainment of gas in liquid pathways.

FIG. 3 depicts an example dripper, shown as a polymeric fitting having a small aperture for breaking up a stream of liquid electrolyte into a series of drops, droplets, slugs or other portions of liquid interspersed with air gaps or gas gaps between them.

FIG. 4 depicts a water stream passing through the metallic aperture of a syringe tip having diameter 0.51 mm, at different flow rates.

FIG. 5 depicts the measured relationship between the velocity of a liquid stream through an aperture (x-axis) and the diameter (or thickness) of the droplets that are formed (y-axis).

FIG. 6 depicts an example a ‘leaf-dripper’.

FIG. 7 depicts an example ‘slug’ flow.

FIG. 8 depicts an example combination of a restrictor, slug chamber, and dripper.

FIG. 9 depicts an example of the use of a gas-filled elbow in a liquid line.

FIG. 10 depicts how an example miniaturised ‘dripper’ fitting may be incorporated into the polymer frame of an example electrochemical cell.

FIG. 11 schematically depicts how multiple cells in a cell stack may be induced to have equal or substantially equal volumes of liquid, e.g. water, passing through them.

FIG. 12 schematically depicts how the components of an example capillary-based electro-synthetic or electro-energy cell may be assembled.

FIG. 13 schematically depicts how example capillary-based electro-synthetic or electro-energy cells may be stacked in an example cell stack.

FIG. 14 schematically depicts liquid features of an example cell stack.

### DETAILED DESCRIPTION

The following modes, features, or aspects, given by way of example only, are described to provide a more precise understanding of the subject matter of a preferred embodiment or embodiments.

### Definitions

A ‘reactant’ is a chemical material that is consumed during an electrochemical reaction.

A ‘product’ is a chemical material that is produced during an electrochemical reaction.

A ‘liquid electrolyte’ is a liquid containing dissolved ions that has the capacity to conduct electricity.

‘Room temperature’ is defined here as 21° C.

A ‘liquid-gas’ cell is defined as an electrochemical cell that has at least one liquid-phase reactant or product, and at least one gas-phase reactant or product.

An ‘electro-energy cell’ is an electrochemical cell that generates electrical power continually or continuously, during operation, over indefinite periods of time, for use outside of the cell. Electro-energy cells may require a constant external supply of reactants during operation. The products of the electrochemical reaction also may be constantly removed from such cells during operation. An electro-energy cell may be a liquid-gas cell. An example of an electro-energy cell is a hydrogen-oxygen fuel cell. This example is also a liquid-gas cell.

An ‘electro-synthetic cell’ is an electrochemical cell that manufactures one or more chemical materials continually or continuously, during operation, over indefinite periods of time, for use outside the cell. The chemical materials may be in the form of a gas, liquid, or solid. Like an electro-energy cell, an electro-synthetic cell may also require a constant supply of reactants and a constant removal of products during operation. Electro-synthetic cells may generally further require a constant input of electrical energy during operation. An electro-synthetic cell may be a liquid-gas cell. An example of an electro-synthetic cell is a water electrolysis cell. This example is also a liquid-gas cell.

Electro-energy and electro-synthetic cells differ from other types of electrochemical cells, such as batteries, sensors and the like, in that they do not incorporate within the cell body all/some of the reactants they require to operate, nor all/some of the products they generate during operation. These may be, instead, constantly brought in from, or removed to the outside of the cell during operation. For example, electro-energy cells are distinguished from galvanic cells in that galvanic cells store their reactants and products within the cell body. Unlike a battery, an electro-energy cell does not store chemical or electrical energy within it. Similarly, while some electrochemical sensors may consume reactants and generate products in limited quantities during the sensing operation, all/some of these are stored within the cell body itself.

The ‘energy efficiency’ of an electro-synthetic cell is herein defined as the net energy present within a single unit output of a chemical product, divided by the net energy consumed by the cell to produce that same unit output of the chemical product, expressed as a percentage. The ‘energy efficiency’ of an electro-energy cell is herein defined as the energy produced by the cell per unit time, divided by the maximum theoretical energy that may be produced by the cell per unit time, expressed as a percentage.

An ‘overflow weir’, should be read as also being or referring to an overflow opening, an overflow aperture, an overflow waterfall, an overflow dam, an overflow dike, an overflow levee, an overflow barrier, an overflow cataract, an overflow boom, or an overflow wall, over or through which excess liquid electrolyte flows when the level of the liquid electrolyte exceeds the extent, level, or height, of the overflow weir.

A ‘dripper’ is defined here as a device that, over relatively long periods of continuous or continual operation, consistently and reliably breaks up a relatively constant flow of liquid into a series of drops, droplets, slugs or other segments of liquid interspersed with gas gaps, for example air gaps, between them. In the case where the liquid is a conductive liquid electrolyte, the dripper, in so doing, breaks the conductive pathway through the liquid electrolyte stream. Reference to a drop is to be read as a reference to a drop, droplet, slug or other segment of liquid interspersed with gas gaps. A ‘relatively long period of continuous or continual operation’ is to be read to include periods of hours, days, weeks, months, or years of continuous or continual operation. Preferably, the gas gaps, for example air gaps, constitute electrically non-conducting voids, i.e. non-conducting gas voids, that, effectively, break the electrical conductivity of an incoming stream of liquid electrolyte that is otherwise electrically conductive along the incoming stream. That is, where the liquid passing through a dripper is electrically conductive, preferably, the liquid body on one side of a dripper is not in electrically conductive contact with the liquid body on the other side of the dripper due to the breaking of the liquid stream passing via the dripper, into a continuous, consistent, uniform and/or regular stream of drops, droplets, slugs, or other portions of liquid electrolyte, with gas gaps, for example air gaps, between them. To properly break the conduction pathway, the action of a dripper is, preferably, dependable, and reliable, if not largely unfailing, over relatively long periods of time of continuous or continual operation. It is to be understood that drippers are engineering devices whose performance in consistently, reliably, and repeatedly breaking up liquid streams over relatively long periods of time, is critical to their functioning. That is, preferably, a dripper must reliably, dependably, if not unfailingly, over relatively long periods of continuous or continual operation, break the liquid stream passing through it into a continuous, consistent, uniform and/or regular stream of drops, droplets, slugs, or other portions of liquid electrolyte, with gas gaps, for example air gaps, between them. It is to be further understood that not all devices that create droplets from liquid streams may be considered ‘drippers’ as defined herein. For example, devices that occasionally or sometimes form droplets from liquid streams are not ‘drippers’. Other devices that ‘mostly’, ‘often’, or even ‘very often’, or that adventitiously break liquid streams into droplets, also do not constitute ‘drippers’ as defined herein, since electrical isolation may not be consistently maintained across the device over relatively long periods of time of continuous or continual operation with conductive electrolytes. Similarly, devices that break up liquid streams irregularly, and/or with varying frequency, and/or for varying durations also do not constitute drippers as defined herein since they may be unable to consistently maintain electrical isolation between bodies of liquid electrolyte on either side of the device over relatively long periods of time. Furthermore, drippers as defined herein, rely for their action, on relatively constant flows of liquid through relatively small apertures or channels that reliably, dependably, and uniformly break up the streams over relatively long periods of time. As such, other types of devices that employ other or different principles of drop formation that may be unreliable over relatively long periods of time when applied in electro-energy or electro-synthetic cells, such as intravenous type drip systems and chambers or agricultural drip systems and chambers, do not constitute ‘drippers’as defined herein.

A ‘liquid electrolyte inlet’ is an opening or aperture at an end of a ‘liquid electrolyte inlet section’. The liquid electrolyte inlet section can be a pipe, conduit, channel or the like.

A ‘liquid electrolyte outlet’ is an opening or aperture at an end of a ‘liquid electrolyte outlet section’. The liquid electrolyte outlet section can be a pipe, conduit, channel or the like.

A ‘porous capillary structure’ is defined as a porous material that employs a capillary action to draw in and hold liquid within it with a capillary pressure. A structure is a porous capillary structure if it exhibits a ‘bubble point’, which is defined as a non-zero gas pressure needed to push the liquid out of the largest capillaries within the porous material. A ‘porous capillary structure’ may have a porous membrane-, a porous plug-, or any other form factor. A ‘porous capillary structure’ can be, alternatively, described as: ‘a porous membrane’, ‘a porous hydrophilic membrane’, ‘a porous plug’, ‘a porous hydrophilic plug’, ‘a structure with fluidic pathways’, ‘a hydrophilic structure with fluidic pathways’, or ‘a porous structure with fluidic pathways’.

A ‘homogeneous liquid phase’ is defined as a body of liquid or a flow of liquid that contains no gas bubbles entrained within it.

A ‘homogeneous gas phase’ is defined as a body of gas or a flow of gas that contains no liquid droplets entrained within it.

A ‘co-mingled liquid and gas phase’ is defined as a body of liquid or a flow of liquid with gas bubbles entrained within it, or a body of gas or a flow of gas with liquid drops, droplets or slugs entrained within it.

A ‘drip chamber’ is defined as a gas-filled cavity through which one or a series of drops, droplets, slugs, or other portions of liquid electrolyte interspersed with gas gaps, for example air gaps, between them, pass. A drip chamber could be provided as a separate cavity or chamber, or as a section of a channel, pipe, conduit, or similar structure.

A ‘drip chamber gas line’ is defined as a channel, pipe, conduit, or similar structure that maintains fluid contact between the gas in a drip chamber and the gas in another gas-filled volume. A ‘drip chamber gas line’ is typically intended to maintain the gas atmosphere in a drip chamber, which may otherwise be lost during relatively long periods of operation. In providing a pathway for gas movement between a larger body of gas and the gas within a drip chamber, a ‘drip chamber gas line’ may also prevent or mitigate fluctuations in the pressure of the gas in a drip chamber during dripping. Such pressure fluctuations may affect the reliability of the dripping action.

A ‘slug’ is a portion of liquid with gas above and below the portion of liquid that is in contact with the walls of a chamber. A ‘slug chamber’ is defined as a cavity through which slugs of liquid, interspersed with gas gaps, for example air gaps, between them, pass. The liquid slugs contact the walls of the slug chamber during their passage. A slug chamber is a specific example type of a drip chamber.

A ‘slug chamber gas line’ is defined as a channel, pipe, conduit, or similar structure that contains gas and that opens into a slug chamber. Liquid passing through a slug chamber fitted with such a gas line, may draw gas out of the gas line and entrain it in the liquid flow pathway, breaking the liquid flow into slugs. A venturi effect may be harnessed to create slug flow in a slug chamber fitted with a slug chamber gas line. A slug chamber gas line is a specific example type of a drip chamber gas line.

A ‘liquid pathway’ is defined as a channel, pipe, conduit, or similar structure along which liquid is intended to flow.

A ‘cell stack’ is defined as an assembly of cells, wherein the cells are stacked adjacent to or abutting each other along a single dimensional axis.

Cell stacks may take the form of a ‘filter-press’ arrangement, which is defined as a cell stack wherein the cells are substantially flat and compressed against each other between endplates during its assembly and/or operation.

A ‘header’ is a channel, a tube, a chamber, or a trough formed by the combination of apertures in individual cells in a cell stack, for conveying a fluid through the full thickness of a cell stack.

A ‘header aperture’ is an aperture in a cell that, when combined with the equivalent header aperture in other cells in the stack, forms the corresponding ‘header’.

A ‘manifold’ is one or more pipes, tubes, chambers, or channels with multiple openings, for conveying a fluid. A header may also be a manifold.

A cell is ‘stackable’ if it is designed to be deployed in a cell stack. For example, in the case of a filter-press-type cell stack, it may contain openings that interface with the openings in other cells in the stack to form headers or manifolds.

A ‘restrictor’ is defined as a liquid-carrying channel that creates a pressure drop in the liquid passing through the restrictor. It may also slow and/or regulate the rate of flow of the liquid along a liquid channel. A restrictor may comprise a liquid-carrying channel with multiple bends in the restrictor; i.e. a tortuous path restrictor. A restrictor may also comprise a fine structure through which liquid requires a certain pressure to pass. Restrictors may typically be polymeric or metallic structures, for example sintered metal structures.

A ‘shunt current’ is defined as a current within a liquid pathway in the system that circumvents the desired inter-electrode current within each cell. Shunt currents are also known as ‘bypass’currents.

The ‘energy efficiency’ of an electro-synthetic cell is herein defined as the net energy present within a single unit output of a chemical product, divided by the net energy consumed by the cell to produce that same unit output of the chemical product, expressed as a percentage. The ‘energy efficiency’ of an electro-energy cell is herein defined as the energy produced by the cell per unit time, divided by the maximum theoretical energy that may be produced by the cell per unit time, expressed as a percentage.

An inter-electrode porous capillary spacer, also known as an inter-electrode porous capillary separator, is defined as stated in International Patent Publication Nos. WO2022056603, WO2022056604, WO2022056605, and WO2022056606, which are hereby incorporated by reference.

### Preferred Embodiments

The inventors discovered that the volume of liquid electrolyte within an electro-synthetic or electro-energy cell or half-cell, preferably a thin, stackable, machined or injection-moulded polymeric electro-synthetic or electro-energy cell or half-cell, may be simultaneously maintained at a constant level (i.e. a constant volume or a substantially constant volume) and also electrically isolated from the liquid electrolyte in other cells.

The level (and volume) of liquid electrolyte in the cell or half-cell may be regulated by passing excess liquid electrolyte into the cell (or half-cell) and then out of the cell (or half-cell) over an overflow weir that forms or is part of the liquid electrolyte outlet of the cell (or half-cell). The height (or extent) of the overflow weir sets the level (and volume) of the liquid electrolyte within the cell (or half-cell). The overflow weir is a feature over which liquid electrolyte flows from one region or level in the cell to another region or level outside the cell (or half-cell). The height or level of an overflow weir is relative to the internal bottom (i.e. base or floor) of the cell upon which the liquid electrolyte sits due to gravity. The cell is in a vertical orientation with respect to gravity. The overflow weir may be miniature in its physical dimensions. The electrical isolation may be achieved by passing broken streams of liquid electrolyte into and out of the cell or half-cell. A broken stream is a flow of liquid electrolyte in which the liquid electrolyte passes through a ‘dripper’, preferably a miniature ‘dripper’, which segments the liquid electrolyte into a series of drops (i.e. droplets, slugs or other portions of liquid) interspersed with gas gaps, for example air gaps, between the drops. The effect of the gas gaps is to break any electrically conductive pathway through the liquid electrolyte stream.

The inventors developed drippers that may break up the flow of liquid electrolyte immediately the liquid electrolyte exits the outlet of the dripper. That is, the flow of liquid electrolyte may be made non-continuous immediately the liquid electrolyte leaves the dripper. The dripper itself may remain filled with the liquid electrolyte throughout its operation. Moreover, the drippers may be configured to reliably, and dependably, if not unfailingly, over relatively long periods of time, control the size of the created drops, droplets, slugs, or other portions of liquid electrolyte interspersed with gas gaps, for example air gaps, between them. For example, the drops, droplets, slugs, or other portions of liquid electrolyte (herein all referred to as ‘drops’) may be made consistently and uniformly very small, even over relatively long periods of time, such as over days, weeks, or months of continuous operation. The combination of an immediate breaking up of the flow of the liquid electrolyte and the creation of drops with small size, enables the height and lateral dimensions of the gas-filled ‘drip chamber’ that is positioned below the dripper, to be small. That is, the components needed to create an overflow weir and a broken stream of liquid electrolyte may be miniaturised, rendering the components suitable for use in thin, flat electrochemical cells, such as the cells that are typically employed in industrial electro-synthetic or electro-energy ‘cell stacks’, for example the ‘filter-press’-type cell stacks used in commercial electrolysers, fuel cells, and the like.

Accordingly, example embodiments can be implemented using one or more overflow weirs that have small dimensions, e.g. one or more miniature overflow weirs, for reliably regulating the level and volume of liquid electrolyte in the cell (or half-cell) and one or more drippers and drip chambers that have small dimensions, e.g. one or more miniature drippers and drip chambers, for reliably, dependably, if not unfailingly creating a broken or segmented stream or flow of liquid electrolyte, whose drops, droplets, slugs, or other portions of liquid electrolyte are interspersed with air gaps or gas gaps between them. Moreover, the electrochemical cells into which these features are incorporated also may be ‘stackable’, as well as polymeric in nature, being machined or moulded, for example injection moulded.

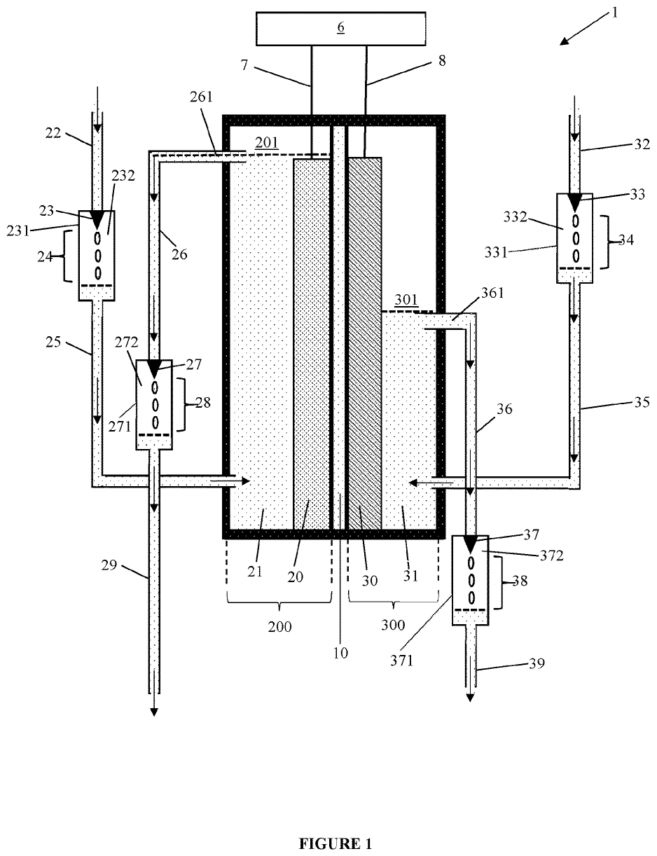

FIG. 1 schematically depicts an example electrochemical cell 1 in cross-section. The cell 1 comprises of an electrode separator 10 positioned between, preferably sandwiched between, a cathode 20 (i.e. a first electrode 20) and an anode 30 (i.e. a second electrode 30). The cell 1 has an electrical power supply or power receiver 6, with first electrical conductor 7 and second electrical conductor 8 (i.e. electrical conductors 7, 8) that connect to a cathode 20 and an anode 30 respectively. The cathode 20 may, optionally, be configured to be in direct contact with a catholyte liquid electrolyte 21 (i.e. liquid catholyte 21) as shown in FIG. 1. The anode 30 may, optionally, be configured to be in direct contact with an anolyte liquid electrolyte 31 (i.e. liquid anolyte 31) as shown in FIG. 1. (As described in International Patent Publication Nos. WO2022056603, WO2022056604, WO2022056605, and WO2022056606, which are hereby incorporated by reference, the cathode 20 and the anode 30 may, optionally, not be in direct contact as shown in FIG. 1, with a catholyte liquid electrolyte or an anolyte liquid electrolyte, respectively). The cell 1 is therefore divided into two half-cells—a cathode half-cell 200 and an anode half-cell 300. The cathode half-cell 200 may, at all operational times, require liquid catholyte 21 to be maintained at first level 201 (or first height 201). The anode half-cell 300 may, at all operational times, require liquid anolyte 31 to be maintained at second level 301 (or second height 301).

Preferably, as illustrated in FIG. 1, the first level 201 is different to the second level 301, however in some examples the first level 201 may be equal to the second level 301. It should be noted that although the example cell 1 in FIG. 1 illustrates the first level 201 (associated with cathode half-cell 200) as higher than the second level 301 (associated with anode half-cell 300), other example cells can have the first level 201 (associated with cathode half-cell 200) as lower than the second level 301 (associated with anode half-cell 300).

That is, in various examples:
(i) a first level of a first overflow weir (associated with a cathode half-cell) is higher than a second level of a second overflow weir (associated with an anode half-cell);
(ii) a first level of a first overflow weir (associated with a cathode half-cell) is lower than a second level of a second overflow weir (associated with an anode half-cell); or
(iii) a first level of a first overflow weir (associated with a cathode half-cell) is equal to a second level of a second overflow weir (associated with an anode half-cell).

Thus, referring to FIG. 1, there is provided an electro-energy or electro-synthetic cell 1, comprising a cathode half-cell 200 and an anode half-cell 300. Cathode half-cell 200 comprises cathode 20, optionally configured to contact liquid catholyte 21. Catholyte inlet second section 25 (i.e. an electrolyte inlet section providing a catholyte inlet) is for supplying the liquid catholyte 21 to the cathode half-cell 200. Catholyte outlet first section 26 is for removing the liquid catholyte 21 from the cathode half-cell 200. An input or opening for catholyte outlet first section 26 (i.e. an electrolyte outlet section providing a catholyte outlet) is positioned at a first level (or height) 201, being higher in the cathode half-cell 200 than an output or opening of catholyte inlet second section 25 (i.e. catholyte inlet). The catholyte first section outlet 26 (i.e. catholyte outlet) provides a first overflow weir 261 over or through which excess liquid catholyte 21 flows out of the cathode half-cell 200.

Anode half-cell 300 comprises anode 30, optionally configured to contact liquid anolyte 31. Anolyte inlet second section 35 (i.e. an electrolyte inlet section providing an anolyte inlet) is for supplying the liquid anolyte 31 to the anode half-cell 300. Anolyte outlet first section 36 (i.e. an electrolyte outlet section providing an anolyte outlet) is for removing the liquid anolyte 31 from the anode half-cell 300. An input or opening for anolyte outlet first section 36 (i.e. anolyte outlet) is positioned at a second level (or height) 301, being higher in the anode half-cell 300 than an output or opening of anolyte inlet second section 35 (i.e. anolyte inlet). The anolyte outlet first section 36 (i.e. anolyte outlet) provides a second overflow weir 361 over or through which excess liquid anolyte 31 flows out of the anode half-cell 300. An electrode separator 10 is positioned between the cathode 20 and the anode 30.

In one example the inlets and outlets are openings or apertures in ends of inlet pipes and outlet pipes. Any inlet and/or outlet can be provided as an opening or aperture, or other type of end, in an inlet section and/or an outlet section, which can be provided as a pipe, a channel, a conduit, a tube or a similar structure for directing the flow of a liquid. The liquid catholyte level 201 may be created and maintained indefinitely by placing an outlet pipe 26 (i.e. catholyte outlet first section 26) in the cathode half-cell 200 and then constantly pumping an excess of liquid catholyte 21 into the cathode half-cell 200 from inlet pipe 25 (i.e. catholyte inlet second section 25).

Liquid electrolyte inlets are provided as openings or apertures at ends of liquid electrolyte inlet sections (e.g. catholyte inlet second section 25 and anolyte inlet second section 35). The liquid electrolyte inlet sections can be pipes, conduits, channels or the like. At least one dripper (e.g. drippers 23, 33) are positioned in the liquid electrolyte inlet sections, for example positioned inside and in-line with the liquid electrolyte inlet sections. That is, at least one dripper (e.g. drippers 23, 33) is in fluid communication with a liquid electrolyte inlet.

Liquid electrolyte outlets are provided as openings or apertures at ends of liquid electrolyte outlet sections (e.g. catholyte outlet first section 26 and anolyte outlet first section 36). The liquid electrolyte outlet sections can be pipes, conduits, channels or the like. At least one dripper (e.g. drippers 27, 37) are positioned in the liquid electrolyte outlet sections, for example positioned inside and in-line with the liquid electrolyte outlet sections. That is, at least one dripper (e.g. drippers 27, 37) is in fluid communication with a liquid electrolyte outlet.

That is, outlet pipe 26 forms an overflow weir 261 over which excess liquid catholyte 21 constantly flows to indefinitely maintain the liquid catholyte level 201 of liquid catholyte 21 in cathode half-cell 200 as constant.

The liquid anolyte level 301 may be similarly created and maintained indefinitely by placing an outlet pipe 36 (i.e. anolyte outlet first section 36) in the anode half-cell 300 and then constantly pumping an excess of liquid anolyte 31 into the anode half-cell 300 from inlet pipe 35 (i.e. anolyte inlet second section 35).

That is, outlet pipe 36 forms an overflow weir 361 over which excess liquid anolyte 31 flows to indefinitely maintain the liquid anolyte level 301 of liquid anolyte 31 in anode half-cell 300 as constant.

In this way it becomes possible to reliably maintain the quantity and level of liquid electrolyte (i.e. liquid catholyte and/or liquid anolyte) in each half-cell at pre-determined levels, or heights, without the need for electronic or mechanical level sensors. Additionally, corrosive electrolytes can be accommodated by using corrosion-resistant materials and pipes. Most electronic level sensors and many mechanical level sensors are unable to operate indefinitely with corrosive electrolytes.

It is to be understood that, while separate inlets and outlets are depicted in FIG. 1 for each of the two different half-cells, in another example only a single inlet may be used in the cell. For example, if the inter-electrode separator 10 is porous and allows liquid electrolyte to freely pass through it, and the electrodes (cathode 20 and anode 30) are porous and allow liquid to flow through them, then it may be possible to regulate the level of liquid electrolyte in the cell by having a single inlet (for example into the cathode half-cell, or into the anode half-cell). Similarly, if only one half-cell requires its liquid electrolyte level to be regulated, or if the liquid level in the two half-cells must be maintained at the same level, then in other examples the level of liquid electrolyte in the cell may be regulated by having a single outlet (for example into the cathode half-cell, or into the anode half-cell). A multiplicity of inlet and outlet arrangements are possible, depending on the nature of the cell, its components, and the electrochemical reaction itself. Such variations fall within the scope of the preferred embodiments and are included herein.

The desired electrical current in an electrochemical cell 1 of this type will flow from one electrode to the other electrode in the cell, for example from the cathode 20 to the anode 30, or from the anode 30 to the cathode 20. However, if the catholyte 21 is in fluid communication with the catholyte in other cells (not shown in FIG. 1), and the cathode in such a separate cell is polarised at a notably different voltage to the cathode 20, then the voltage difference may cause an unwanted current to flow between the two cathodes. Such currents are termed ‘shunt’ currents (also known as ‘bypass’ currents, or ‘corrosion’ currents).

Similarly, if the anolyte 31 is in fluid communication with the anolyte in another cell (not shown in FIG. 1), and the anode in such a separate cell is polarised at a notably different voltage to anode 30, then the voltage difference may cause a shunt current to flow between the two anodes.

Shunt currents constitute undesirable currents that may reduce the efficiency of the electrochemical reaction, induce unwanted electrochemical effects such as formation of the wrong product (or no product being formed) in unexpected locations, or they may induce unwanted corrosion, shortening the lifetime of the cell.

It is also to be understood that shunt currents may flow between any conductive surfaces or electrodes with notably different voltages within an electrochemical system, provided only that the conductive surfaces or electrodes share and are in contact via a common/contiguous liquid electrolyte.

The inventors realised that shunt currents can be prevented by breaking potential conductive pathways in a shared or common liquid electrolyte.

FIG. 1 depicts how potential conductive pathways via a shared or common liquid electrolyte may be broken, thereby electrically isolating cell 1 from other cells or other parts of the electrochemical system and avoiding shunt currents.

To help electrically isolate cathode 20 and liquid catholyte 21, liquid catholyte flowing into the cathode half-cell 200 via catholyte inlet first section 22 may be passed through a first dripper 23 (or a plurality of drippers, not illustrated), that breaks the liquid stream or flow into drops 24 (or droplets, slugs or other segments of liquid) interspersed with gas gaps, for example air gaps, between them, within a gas-filled first drip chamber 231 positioned below the first dripper 23. The drops 24 fall through the gas 232 in first drip chamber 231 and then, at the base of the first drip chamber 231, recombine into a bulk homogeneous liquid phase that flows through catholyte inlet second section 25 into the cell 1. As gases are non-conductive, a conductive electrical pathway then does not exist between the liquid catholyte in catholyte inlet first section 22 and the liquid catholyte in catholyte inlet second section 25. That is, the conductive pathway between the liquid catholyte in catholyte inlet first section 22 and the liquid catholyte in catholyte inlet second section 25 is broken by the effect of the dripping action. The first dripper 23 and the first drip chamber 231 are positioned in-line between catholyte inlet first section 22 and catholyte inlet second section 25.

To fully electrically isolate cathode 20 and liquid catholyte 21, liquid electrolyte (i.e. liquid catholyte 21) flowing out of the cathode half-cell 200 via catholyte outlet first section 26 may be passed through a second dripper 27 (or a plurality of drippers, not illustrated) that breaks the liquid stream into drops 28 (or droplets, slugs or other segments of liquid) interspersed with gas gaps, for example air gaps, between them, within a second drip chamber 271 filled with gas 272 and positioned below the second dripper 27. The drops 28 fall through the gas 272 and then, at the base of second drip chamber 271, recombine into a bulk liquid homogeneous phase that flows through catholyte outlet second section 29 out of the cathode half-cell 200 and out of cell 1. As gases are non-conductive, a conductive electrical pathway then does not exist between the liquid catholyte in catholyte outlet first section 26 and the liquid catholyte in catholyte outlet second section 29. That is, the conductive pathway between the liquid catholyte in catholyte outlet first section 26 and the liquid catholyte in catholyte outlet second section 29 is broken by the effect of the dripping action. The second dripper 27 and the second drip chamber 271 are positioned in-line between catholyte outlet first section 26 and catholyte outlet second section 29.

Anode 30 and liquid anolyte 31 may be similarly electrically isolated by introducing third dripper 33 and fourth dripper 37 into the anolyte inlet and anolyte outlet respectively.

To help electrically isolate anode 30 and liquid anolyte 31, liquid anolyte flowing into the anode half-cell 300 via anolyte inlet first section 32 may be passed through a third dripper 33 (or a plurality of drippers, not illustrated), that breaks the liquid stream into drops 34 (or droplets, slugs or other segments of liquid) interspersed with gas gaps, for example air gaps, between them, within a third gas-filled drip chamber 331 positioned below the third dripper 33. The drops 34 fall through the gas 332 in the third drip chamber 331 and then, at the base of the third drip chamber 331, recombine into a bulk homogeneous liquid phase that flows through anolyte inlet second section 35 into the cell 1. As gases are non-conductive, a conductive electrical pathway then does not exist between the liquid anolyte in anolyte inlet first section 32 and the liquid anolyte in anolyte inlet second section 35. That is, the conductive pathway between the liquid anolyte in anolyte inlet first section 32 and the liquid anolyte in anolyte inlet second section 35 is broken by the effect of the dripping action. The third dripper 33 and the third drip chamber 331 are positioned in-line between anolyte inlet first section 32 and anolyte inlet second section 35.

To fully electrically isolate anode 30 and liquid anolyte 31, liquid electrolyte (i.e. liquid anolyte 31) flowing out of the anode half-cell 300 via anolyte outlet first section 36 may be passed through a fourth dripper 37 (or a plurality of drippers, not illustrated) that breaks the liquid stream into drops 38 (or droplets, slugs or other segments of liquid) interspersed with gas gaps, for example air gaps, between them, within a fourth drip chamber 371 filled with gas 372 and positioned below the fourth dripper 37. The drops 38 fall through the gas 372 and then, at the base of fourth drip chamber 371, recombine into a bulk liquid homogeneous phase that flows through anolyte outlet second section 39 out of the anode half-cell 300 and out of cell 1. As gases are non-conductive, a conductive electrical pathway then does not exist between the liquid anolyte in anolyte outlet first section 36 and the liquid anolyte in anolyte outlet second section 39. That is, the conductive pathway between the liquid anolyte in anolyte outlet first section 36 and the liquid anolyte in anolyte outlet second section 39 is broken by the effect of the dripping action. The fourth dripper 37 and the fourth drip chamber 371 are positioned in-line between anolyte outlet first section 36 and anolyte outlet second section 39.

In this way, it becomes possible to prevent shunt currents between components within cell 1 and other parts, including other cells, of the electrochemical system. However, this depends on the intrinsic capacity of each dripper to reliably and dependably, if not unfailingly, over relatively long periods of time, break the liquid stream passing through it into a continuous, consistent, uniform and/or regular stream of drops, droplets, slugs, or other portions of liquid electrolyte, with gas gaps, for example air gaps, between them.

Preferably, the gas gaps, for example air gaps, constitute electrically non-conducting voids, i.e. non-conducting gas voids, that, effectively, break the electrical conductivity of the incoming stream of liquid electrolyte that is otherwise electrically conductive along the incoming stream. That is, preferably, the conductive liquid electrolyte body on one side of a dripper is not in electrically conductive contact with the conductive liquid electrolyte body on the other side of the dripper due to the breaking of the liquid stream by the dripper, into a continuous, consistent, uniform and/or regular stream of drops, droplets, slugs, or other portions of liquid electrolyte, with gas gaps, for example air gaps, between them. To properly break the conduction pathway, the action of a dripper is, preferably, dependable, and reliable, if not largely unfailing, over relatively long periods of time of continuous or continual operation.

Thus, referring to FIG. 1 there is provided an electro-energy or electro-synthetic cell that comprises the cathode and the anode, with the liquid electrolyte inlet for supplying a liquid electrolyte to the cell and the liquid electrolyte outlet for removing the liquid electrolyte from the cell. The liquid electrolyte outlet comprises an overflow weir over which excess liquid electrolyte flows.

In another embodiment, referring to FIG. 1, the electro-energy or electro-synthetic cell comprises the cathode and the anode, with the liquid electrolyte inlet for supplying the liquid electrolyte to the cell, and the liquid electrolyte outlet for removing the liquid electrolyte from the cell. The liquid electrolyte inlet and/or the liquid electrolyte outlet are part of, e.g. ends of, a liquid electrolyte inlet section and a liquid electrolyte outlet section which each or both can include at least one dripper.

In another embodiment, referring to FIG. 1, the electro-energy or electro-synthetic cell, comprises the cathode and the anode, with the liquid electrolyte inlet for supplying the liquid electrolyte to the cell, and the liquid electrolyte outlet for removing the liquid electrolyte from the cell, and the liquid electrolyte outlet forming or including the overflow weir over which excess liquid electrolyte flows, and the liquid electrolyte inlet and/or the liquid electrolyte outlet being in fluid communication with at least one dripper.

In one example, the liquid electrolyte outlet comprises an overflow weir over which excess liquid electrolyte flows.

In another example the liquid electrolyte is a liquid catholyte; the liquid electrolyte inlet is a liquid catholyte inlet for supplying the liquid catholyte to a cathode half-cell; and the liquid electrolyte outlet is a liquid catholyte outlet for removing the liquid catholyte from the cathode half-cell, the liquid catholyte outlet forming or comprising an overflow weir over which excess liquid catholyte flows.

In another example the liquid electrolyte is a liquid anolyte; the liquid electrolyte inlet is a liquid anolyte inlet for supplying the liquid anolyte to an anode half-cell; and the liquid electrolyte outlet is a liquid anolyte outlet for removing the liquid anolyte from the anode half-cell, the liquid anolyte outlet forming or comprising an overflow weir over which excess liquid anolyte flows.

In other examples, an overflow weir sets a level of the liquid electrolyte in the cell; an overflow weir sets a level of the liquid catholyte in the cathode half-cell, and/or an overflow weir sets a level of the liquid anolyte in the anode half-cell.

In other examples, the liquid electrolyte inlet section includes a dripper, the liquid electrolyte outlet section includes a dripper, the liquid catholyte inlet section includes a dripper and/or the liquid catholyte outlet section includes a dripper, the liquid anolyte inlet section includes a dripper and/or the liquid anolyte outlet section includes a dripper, and/or the dripper breaks the flow of the liquid electrolyte into drops of liquid electrolyte interspersed with gas gaps between the drops.

In another example aspect, a drip chamber need not be a distinct or separate cavity or chamber, but instead could be a section or a part of a channel, pipe, conduit, or similar structure. In this case, the height of the drip chamber could be defined as the distance between the end point of the dripper from which drops emerge and the surface of the liquid underneath the dripper. For example, the first drip chamber 231 could be provided as a part or a section of the catholyte inlet pipe, still positioned in-line between catholyte inlet first section 22 and catholyte inlet second section 25. For example, the second drip chamber 271 could be provided as a part or a section of the catholyte outlet pipe, still positioned in-line between catholyte outlet first section 26 and catholyte outlet second section 29. For example, the third drip chamber 331 could be provided as a part or a section of the anolyte inlet pipe, still positioned in-line between anolyte inlet first section 32 and anolyte inlet second section 35. For example, the fourth drip chamber 371 could be provided as a part or a section of the anolyte outlet pipe, still positioned in-line between anolyte outlet first section 36 and anolyte outlet second section 39.

In another example aspect (not illustrated in FIG. 1), a further dripper, and a further drip chamber positioned below the further dripper, are provided in fluid communication with the dripper and the drip chamber. Preferably, the further dripper and the further drip chamber are positioned in the liquid catholyte inlet section, the liquid catholyte outlet section, the liquid anolyte inlet section or the liquid anolyte outlet section in-line with the dripper and the drip chamber, for example positioned either above or below the dripper and the drip chamber. That is, in some examples two or more drippers, and associated drip chambers, can be positioned in-line and in liquid electrolyte channels or conduits, for example in-line and in the liquid catholyte inlet section, the liquid catholyte outlet section, the liquid anolyte inlet section and/or the liquid anolyte outlet section.

In other examples, the gas gaps are air gaps, or the gas gaps are non-conducting gas voids. The gas gaps can be provided via the drip chamber gas line.

In other examples, the level of the liquid electrolyte within the cell or a component half-cell remains substantially constant during operation of the cell. The liquid electrolyte within the cell may be electrically isolated from the liquid electrolyte outside of the cell. The liquid electrolyte on one side of a dripper may be electrically isolated from the liquid electrolyte on the other side of the dripper. The liquid electrolyte within the cell may be electrically isolated from liquid electrolyte in an adjacent cell.

In some examples, the electrical resistance between the liquid electrolyte on one side of a dripper and the liquid electrolyte on the other side of the dripper is greater than 1Ω, greater than 10Ω, greater than 50Ω, greater than 100Ω, greater than 400Ω, greater than 700Ω, greater than 900Ω, greater than 1 kΩ, greater than 5 kΩ, greater than 10 kΩ, greater than 50 kΩ, greater than 100 kΩ, greater than 1 MΩ, greater than 5 MΩ, greater than 10 MΩ, greater than 50 MΩ, greater than 100 MΩ, or greater than 1,000MΩ.

In some examples, the liquid electrolyte inlet section(s), the liquid electrolyte inlet(s), the liquid electrolyte outlet section(s), and/or the liquid electrolyte outlet(s) of the cell, and the devices associated therewith for breaking the flow of liquid electrolyte into drops, droplets, slugs or other portions of liquid interspersed with air or gas gaps between them (that is the drippers or the drip chambers), are miniature in size, having a thickness or a diameter less than 50 mm, less than 30 mm, less than 20 mm, less than 10 mm, less than 8 mm, less than 6 mm, less than 4 mm, less than 2 mm, less than 1 mm, less than 0.5 mm, or less than 0.25 mm.

In some examples, the liquid electrolyte inlet(s) and/or the liquid electrolyte outlet(s) of the cell and the devices associated therewith for breaking the flow of liquid electrolyte into drops, droplets, slugs, or other portions of liquid interspersed with air or gas gaps between them (that is the drippers), incorporate small apertures that break up the flow into small droplets. Preferably, the apertures have a thickness less than 5 mm, less than 3 mm, less than 2 mm, less than 1 mm, less than 0.8 mm, less than 0.6 mm, less than 0.4 mm, less than 0.2 mm, less than 0.1 mm, less than 0.05 mm, or less than 0.025 mm.

In some examples, the drops, droplets, slugs or other portions of liquid interspersed with gas gaps, for example air gaps, between them, that are created by the at least one dripper in the liquid electrolyte inlet section(s) and the at least one dripper in the liquid electrolyte outlet section(s) of the cell, are small, having a diameter or thickness of less than 5 mm, less than 3 mm, less than 2 mm, less than 1 mm, less than 0.8 mm, less than 0.6 mm, less than 0.4 mm, less than 0.2 mm, less than 0.1 mm, less than 0.05 mm, or less than 0.025 mm.

In some examples, a gas-filled drip chamber positioned below a dripper has a height less than 50 mm, less than 30 mm, less than 20 mm, less than 15 mm, less than 12 mm, less than 10 mm, less than 9 mm, less than 8 mm, less than 7 mm, less than 6 mm, less than 5 mm, or less than 3 mm.

Preferably, a gas-filled drip chamber positioned below a dripper has a diameter or width of less than 50 mm, less than 30 mm, less than 20 mm, less than 10 mm, less than 8 mm, less than 6 mm, less than 4 mm, less than 2 mm, less than 1 mm, less than 0.5 mm, or less than 0.25 mm.

In another example, a dripper is impervious to corrosive liquid electrolyte. In another example, the liquid electrolyte inlet(s), the liquid electrolyte inlet section(s), the liquid electrolyte outlet(s), the liquid electrolyte outlet section(s), and the dripper(s) are miniaturised. In another example, the liquid electrolyte inlet(s), the liquid electrolyte inlet section(s), the liquid electrolyte outlet(s), the liquid electrolyte outlet section(s), and the dripper(s) are incorporated into a frame of the cell.

### Porous Capillary Structures

The inventors further discovered means to prevent the gas in the system from entering and becoming entrained in the liquid pathways of the cell.

For example, the gas in a drip chambers is, effectively, below the liquid in the associated dripper and associated liquid pathways above the dripper. To prevent gas from the drip chamber moving upwards into the liquid pathways and co-mingling with the liquid pathways, a porous capillary structure having a bubble point that exceeds the pressure of the gas against the liquid, may be included in the liquid pathway above the drip chamber. For example, the porous capillary structure may be included in the dripper or placed in the liquid pathway immediately above and abutting the dripper or positioned in a location within the liquid pathway that prevents gas from entering and co-mingling with the liquid in the liquid pathway.

A ‘porous capillary structure’ is a porous material that draws in and holds liquid within it by a capillary action, wherein the porous capillary structure has a ‘bubble point’ that is higher than the pressure applied by the gas to enter the liquid stream. A bubble point is defined as a non-zero gas pressure needed to push the liquid out of the largest capillaries within the porous capillary structure. Effectively, porous capillary structures facilitate liquid ingress but resist or hinder gas ingress. Non-limiting examples of porous capillary structures include various porous hydrophilic membranes, porous hydrophilic plugs, and the like. For example, a SUPOR® polyethersulfonate water purification membrane sold by Pall Corporation may comprise a porous hydrophilic membrane that acts as a porous capillary structure.

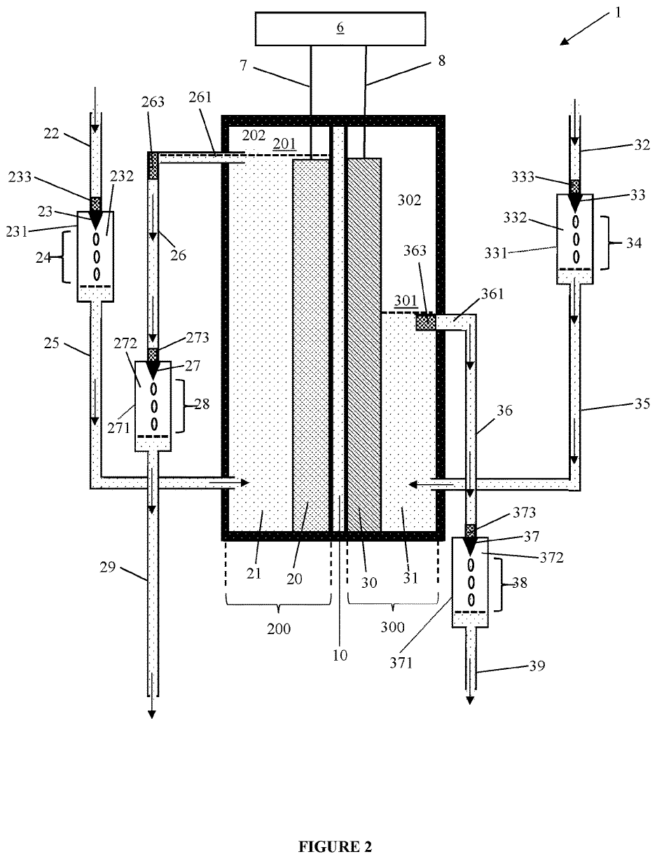

FIG. 2 depicts the cell 1 of FIG. 1, but additionally wherein a first porous capillary structure 233 is installed in the liquid pathway provided by catholyte inlet first section 22, positioned above, and preferably abutting, the first dripper 23, to thereby ensure that gas 232 does not enter into first dripper 23, first porous capillary structure 233 and the liquid pathway provided by catholyte inlet first section 22.

FIG. 2 also depicts a second porous capillary structure 273 that has similarly been installed and positioned above, and preferably abutting, second dripper 27 in the liquid pathway provided by catholyte outlet first section 26 to thereby ensure that gas 272 does not enter into second dripper 27, second porous capillary structure 273 and the liquid pathway provided by catholyte outlet first section 26.

FIG. 2 also depicts a third porous capillary structure 333 that has similarly been installed and positioned above, and preferably abutting, third dripper 33 in the liquid pathway provided by anolyte inlet first section 32 to thereby ensure that gas 332 does not enter into third dripper 33, third porous capillary structure 333 and the liquid pathway provided by anolyte inlet first section 32.

FIG. 2 also depicts a fourth porous capillary structure 373 that has similarly been installed and positioned above, and preferably abutting, fourth dripper 37 in the liquid pathway provided by anolyte outlet first section 36 to thereby ensure that gas 372 does not enter into fourth dripper 37, fourth porous capillary structure 373 and the liquid pathway provided by anolyte outlet first section 36.

In some examples, any one or more of the drippers may incorporate or include the porous capillary structures, or a dripper can be positioned adjacent to, and preferably abut or touch, a porous capillary structure.

Gas may also become entrained in the liquid overflowing over a weir and thereby become entrained and co-mingled with the liquid stream. To prevent this, a porous capillary structure having a bubble point that exceeds the pressure of the gas against the liquid, may be included in the liquid pathway at the weir. For example, the porous capillary structure may be included in the mouth of the weir or placed in the liquid pathway immediately below and abutting the weir or positioned in a location that prevents gas from entering and co-mingling with the liquid passing over the weir.

FIG. 2 depicts the cell in FIG. 1, but additionally wherein a porous capillary structure 263 is located in the liquid pathway provided by catholyte outlet first section 26 (i.e. weir 261), at or below the mouth or opening of weir 261, to thereby ensure that gas 202 (above level 201) is not drawn into and does not co-mingle with the liquid stream passing over the weir 261 and passing along the liquid pathway provided by catholyte outlet first section 26.

FIG. 2 also depicts a porous capillary structure 363 located at the mouth or opening of anolyte outlet first section 36 (i.e. weir 361) to thereby ensure that gas 302 (above level 301) is not drawn into and does not co-mingle with the liquid stream passing over the weir 361 and passing along the liquid pathway provided by anolyte outlet first section 36. Thus, there is provided a first porous capillary structure positioned at or downstream of the first overflow weir and a second porous capillary structure positioned at or downstream of the second overflow weir.

### Example Drippers for Breaking Liquid Flows

The drippers 23, 27, 33, or 37, have the property that they break up liquid streams into a series of drops, droplets, slugs, or other portions of liquid interspersed with gas gaps, for example air gaps, between them. Preferably, the liquid stream is broken up immediately it leaves the dripper and enters the gas atmosphere of the drip chamber, to thereby minimise the height of the gas-filled drip chamber needed below it. Preferably, the liquid stream is broken into drops, droplets, slugs or other portions of liquid interspersed with gas gaps, for example air gaps, between them, having controlled size. Preferably, the drops, droplets, slugs or other portions of liquid interspersed with gas gaps, for example air gaps, between them, have a small size to thereby minimise the width or thickness of the gas-filled drip chamber. These features may be achieved in many ways. Preferably, the dripper reliably and dependably, if not unfailingly, over relatively long periods of continuous or continual operation, breaks the liquid stream passing through it into a continuous, consistent, uniform and/or regular stream of drops, droplets, slugs, or other portions of liquid electrolyte, with gas gaps, for example air gaps, between them.

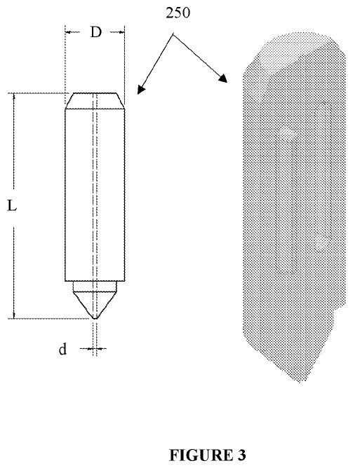

FIG. 3 depicts an example dripper 250 (as shown as a half piece for illustration, to be fitted with another similar half piece to form the complete dripper) that comprises of a very fine internal aperture of diameter d (for example 0.2 mm diameter) through which liquid electrolyte is passed. Dripper 250 has an external diameter D (for example 3.0 mm diameter). Dripper 250 has a length L (for example 10 mm length). When the liquid electrolyte flows through the internal aperture of diameter d at a particular rate, the liquid electrolyte is induced to break up into drops separated by gas gaps, for example air gaps. Preferably, in other examples, the dripper has an internal aperture of diameter d less than or equal to 0.2 mm, the dripper has an external diameter D less than or equal to 3.0 mm, and the dripper has a length L less than or equal to 10 mm. By changing the aperture diameter d, and/or by changing the flow rate of liquid electrolyte through the aperture of the dripper, the drop size (i.e. drop diameter or drop thickness) can be controlled, reduced or minimised.

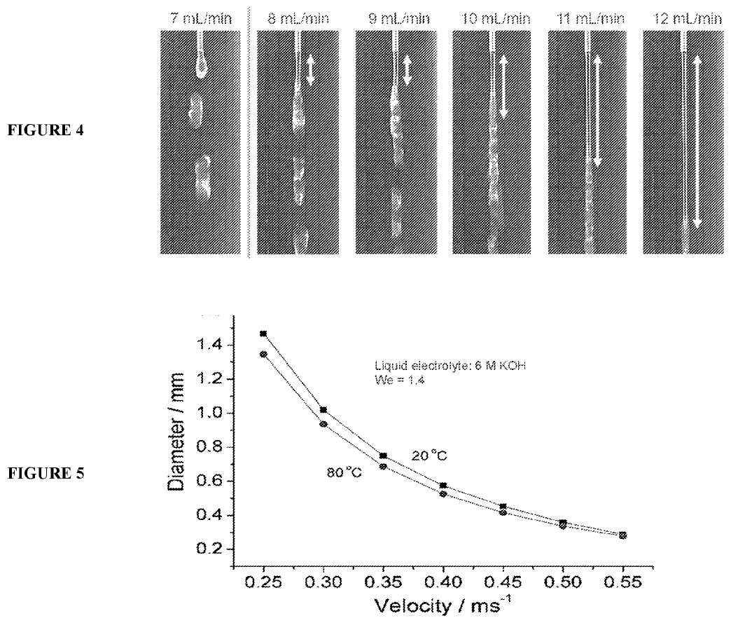

For example, FIG. 4 depicts liquid electrolyte passing through the metallic aperture of a syringe tip having diameter 0.51 mm and entering the gas atmosphere of gas-filled drip chamber. As can be seen, when flowing at less than 7 mL/min, into a volume containing a gas, the flow is broken up into drops (or droplets) separated by gas gaps (left-most image). As gases are essentially non-conductive, the electrical conduction pathway between the liquid in the aperture and the liquid in the bottom-most drop (or droplet) is broken. However, when the flow rate through the aperture is increased to 8 mL/min, 9 mL/min, 10 mL/min and finally 11 mL/min (right-most image), the drops (or droplets) progressively combine to ultimately form a continuous stream of liquid that does not contain gas gaps and therefore does not break the conduction pathway.

This approach may also be used to ‘design’ the size of the drops (or droplets) formed. For example, FIG. 5 depicts a measured relationship for the diameter (or thickness) of the drops (or droplets) as they fall (shown on the y-axis) relative to the velocity of the liquid electrolyte (6 M KOH) passing through an aperture (shown on the x-axis). As can be seen, drops (or droplets) with diameters as small as 0.3 mm could be reliably, and reproducibly produced over a range of temperatures between 20° C. and 80° C. Such a dripper may operate reliably and dependably, if not unfailingly, over relatively long periods of continuous or continual operation, breaking the liquid electrolyte stream passing through it into a continuous, consistent, uniform and/or regular stream of drops, droplets, slugs, or other portions of liquid electrolyte, with gas gaps, for example air gaps, between them.

Preferably, the gas in a drip chamber is not an isolated gas of relatively small fixed volume, since the entry of a liquid stream into such a volume may induce pressure fluctuations that influence and alter the dripping action, thereby affecting its reliability and dependability. Drip systems that rely on the presence of a fixed, relatively small volume of gas in a drip chamber, such as intravenous-type drip systems and chambers, are generally unreliable in electro-synthetic or electro-energy cells, because, while initially fixed, the volume of gas typically changes with time and this affects the reliability and dependability of the dripping action. To avoid the gas volume in a drip chamber being fixed and small, a gas line from a larger body of gas to the drip chamber may be incorporated, as described below. Such a gas line may allow gas to flow freely between the larger body of gas and the drip chamber, thereby maintaining the gas atmosphere in the drip chamber. Such gas flow may also avoid or mitigate pressure fluctuations within the gas in the drip chamber, thereby avoiding the possibility that such pressure fluctuations influence and alter the dripping action, affecting its reliability and dependability, as described above.

Thus, the use of narrow apertures, combined with pre-determined, fixed flow rates can be used to create liquid streams to be reliably and repeatedly broken up into drops (or droplets) that do not allow for continuous electrical conduction, over relatively long periods of continuous or continual operation.

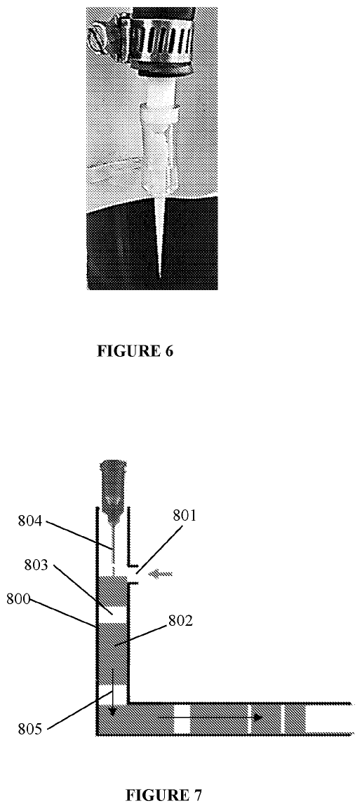

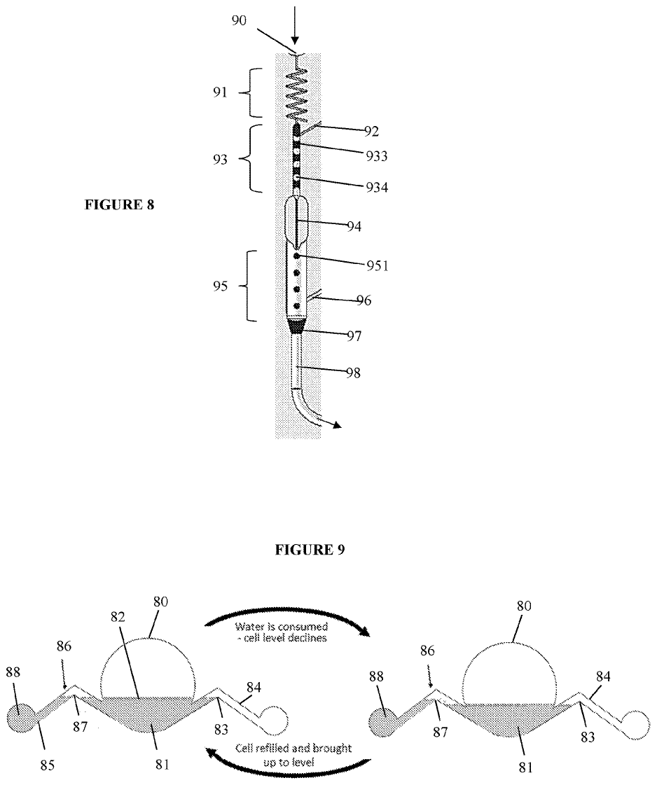

Other example embodiments that may be harnessed as drippers and/or employed to break up or introduce non-conducting gas bodies into liquid streams include:
(1) Leaf-dripper: Flowing the stream of liquid over a structure that terminates in a sharp tip may cause the stream to break up into drops (or droplets). FIG. 6 depicts a ‘leaf dripper’ of this type in which a liquid is flowed over a structure having a sharp tip that causes the stream to break up into a series of drops (or droplets).
(2) Slug-flow: Flowing liquid into a tubular ‘slug chamber’ 800 that has a connection to a gas body via a ‘slug chamber gas line’ 801 may cause the liquid stream to break up into liquid bodies (e.g. liquid body or slug 802) interspersed with gas bodies (e.g. gas body 803). FIG. 7 schematically depicts a fitting of this type in which liquid flowing through a dripper 804 (e.g. a syringe needle) at 9 mL/min is passed into a vertically disposed slug chamber 800 of 3 mm diameter (or less than 3 mm diameter in other examples), which has a horizontally disposed slug chamber gas line 801 with an aperture size of 2.5 mm diameter (or less than 2.5 mm diameter in other examples) near the tip of the dripper 804. Gas drawn through the horizontal slug chamber gas line 801 by the liquid flow 805 causes the liquid flow 805 to break up into ‘slugs’ (e.g. slug 802) separated by gas gaps (e.g. gas gap 803) that may break the conduction pathway through the liquid stream in the slug chamber 800. Slugs (e.g. slug 802) comprise drops or droplets that may touch the walls of the slug chamber 800. A slug chamber that produces non-uniform slugs of liquid and gas may be capable of breaking up or introducing non-conducting gas bodies into liquid streams but may not be suitable as a ‘dripper’ that is capable of reliably and dependably, if not unfailingly, breaking conduction pathways over relatively long periods of time of continuous or continual operation.
(3) A Restrictor: A ‘restrictor’ is a thin channel, which may contain multiple bends (i.e. a tortuous aperture), that may have the effect of creating a pressure drop in liquid passing through the restrictor. A restrictor may also slow and/or regulate the rate of flow along a liquid pathway. A restrictor may be used to create a better controlled flow of drops, droplets or slugs out of a dripper. FIG. 8 schematically depicts an example restrictor 91, which comprises a tortuous, fine, zig-zag channel. A liquid inlet 90 leads to the restrictor 91. A restrictor may also have a bubble point (i.e. a pressure required in a gas to force liquid out of the tortuous aperture). Restrictors may be formed from a polymer or metal, for example an injection moulded polymer restrictor or a sintered metal restrictor. Preferably, a restrictor is positioned upstream of a dripper.
(4) Combinations of Restrictors, Slug Chambers, and Drippers: Combinations of restrictors and/or slug chambers and/or drippers may be used to break up a liquid stream in a more controlled manner. For example, a restrictor may be combined with a slug chamber to better control the flow and uniformity of the slugs produced. In another example, a slug chamber may be combined with a dripper to better control the flow and size of the drops or droplets out of a dripper. A dripper may similarly be combined with a slug chamber to better control the flow and size of the slugs out of a slug chamber. Alternatively, a restrictor and a slug chamber may be used to better control the flow and size of the drops or droplets out of a dripper. A restrictor, a slug chamber and a dripper may be simultaneously used. It is to be understood that any combination of a restrictor, a slug chamber, and/or a dripper may be used in this respect.
A non-limiting example is depicted schematically in FIG. 8. A liquid inlet 90 leads to restrictor 91, which comprises a tortuous, fine, zig-zag structure. The restrictor 91 may create a pressure drop in the liquid passing through it and also slow and/or regulate the rate of flow. Thus, for example, the liquid passing through the restrictor goes from having a higher pressure at inlet 90, to a lower pressure and more controlled flow as it goes down the restrictor 91. The restrictor is positioned upstream of a slug chamber and a dripper. The restrictor 91 deposits the liquid in the slug chamber 93 that contains a slug chamber gas line 92. The slug chamber gas line 92 induces the liquid flow entering the slug chamber 93 to consistently break into uniformly sized liquid slugs 933 interspersed with uniformly sized gas bodies 934, which comprise liquid slugs 933 separated by gas gaps 934. This slug flow is then passed through an aperture-based dripper 94, which converts the flow into drops/droplets 951 within a drip chamber 95 as depicted in FIG. 8. The drip chamber 95 includes a drip chamber gas line 96 to ensure the drip chamber 95 remains filled with gas. The droplets 951 recombine into a homogenous liquid 97 at the bottom of the drip chamber 95, where the liquid 97 flows down a liquid channel 98.
Thus, in one example there is provided restrictor 91 positioned above a slug chamber 93 provided with a slug chamber gas line 92, the slug chamber 93 positioned above a dripper 94 which is positioned above a drip chamber 95 provided with a drip chamber gas line 96.
Drippers, slug chambers, and restrictors may be formed from a polymer or metal, for example an injection moulded polymer dripper, slug chamber or restrictor, or a sintered metal dripper, slug chamber or restrictor. Drippers, slug chambers, and restrictors may be separately fabricated and then be incorporated post-fabrication into a cell or cell frame.
(5) Gas-filled elbow in a liquid line: Incorporating a gas bubble in an elbow in a liquid line may be used to electrically isolate a body of liquid electrolyte and provide a ‘self-filling’ capacity. FIG. 9 (left-side) depicts a cross-section of a spherical half-cell 80 containing liquid electrolyte 81 filled to liquid level 82. The liquid level 82 is set by the height of the elbow 83 in a liquid electrolyte outlet tube 84 that is connected on the right-hand side of the half-cell 80. A liquid electrolyte inlet tube 85 is also attached to the half-cell 80 (on its left-hand side). A gas volume 86 present at the elbow 87 in the liquid electrolyte inlet tube 85 may be used to break the electrical conduction pathway between the liquid 81 in the half-cell 80 and the liquid 88 in the liquid electrolyte inlet tube 85. Referring to FIG. 9 (right-side) when liquid electrolyte (e.g. water) is consumed during operation of the half-cell 80, its liquid level may fall. This causes the gas volume 86 above the elbow 87 in the liquid electrolyte inlet tube 85 to re-arrange, drawing liquid over the elbow 87 in the liquid electrolyte inlet tube 85 and into the cell 80. Liquid will flow over the elbow 87 until the cell liquid level is restored to its original level 82 (i.e. height), after which the gas volume 86 at the elbow 87 will again readjust, so that it once more breaks the electrical conduction pathway.

### Miniaturisation and Incorporation Into Cell Frames

The above-mentioned capacity to design drippers such that the drops (or droplets or slugs) they create have very small size, allows for their ready miniaturisation. As noted above, the overflow weirs described above also may be miniaturised. Such miniaturisation allows these devices to be incorporated in the cell frames used industrially for many electrochemical cells. Such cells and their frames may be flat and as thin as 1 cm or less, making them ‘stackable’. That is they may be stacked in multi-cell stacks, for example filter-press type cell stacks. A cell frame is preferably flat.

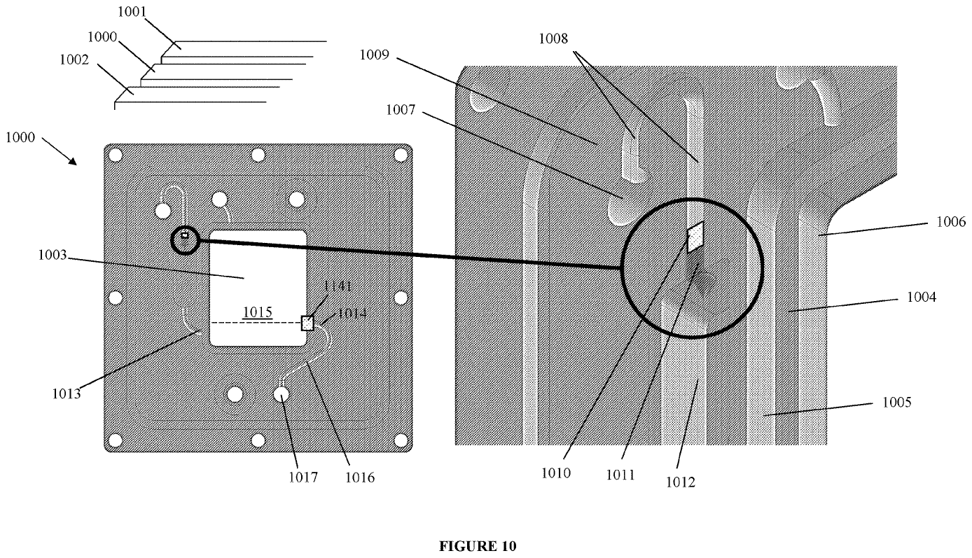

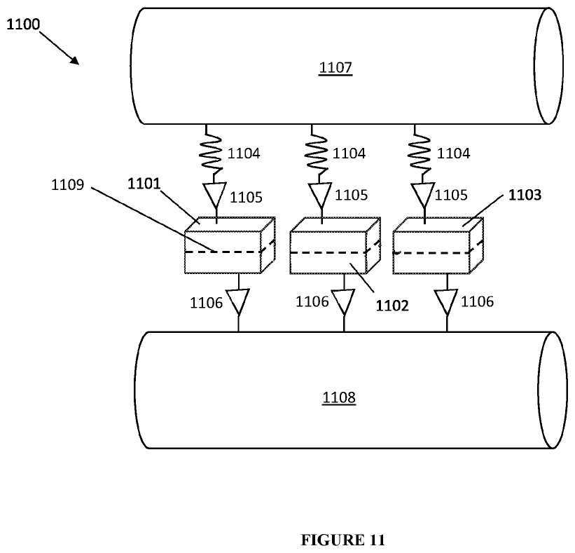

FIG. 10 depicts an example polymeric cell frame 1000 for an electrochemical cell that is to be stacked in a filter-press arrangement of the type used in the electrochemical industry. The frame is flat and square, in one particular example being only 8 mm thick (or less than 8 mm thick in other examples). The frame is intended to be stacked with other identical cell frames, for example frame 1001 and frame 1002, as shown schematically in the top left of FIG. 10. Once stacked, the frames will be tightly compressed against each other to create the filter-press arrangement.

The cell frame 1000 contains a central window 1003 into which an inter-electrode separator is affixed. The inter-electrode separator, which is in one example 0.5 mm thick, is thermally bonded onto the ledge 1004. The anode and cathode electrodes are fitted into the central window on opposite sides of the inter-electrode separator. The anode electrode, which is in one example 0.5 mm thick, is located tight against the inter-electrode separator within, for example, the 4 mm thickness of cut 1005. The cathode electrode, which is in one example 0.5 mm thick, is located tight against the inter-electrode separator within, for example, the 4 mm thickness of cut 1006. In other examples, the anode electrode is less than 0.5 mm thick and the cathode electrode is less than 0.5 mm thick.

The cell frame has a liquid header aperture 1007 for transporting liquid electrolyte to the cell. When the other cell frames (e.g. 1001 and 1002) are compressed against cell frame 1000, liquid header aperture 1007 will join with the equivalent liquid header apertures in the other cell frames to form a liquid-carrying ‘header’, which is a pipe, channel or conduit that runs through all of the cells in the filter-press arrangement formed by the combination of the above-mentioned liquid header apertures 1007 in all of the cells in the cell stack. The header is in fluid communication with each cell in the stack of cells.

On cell frame 1000, liquid header aperture 1007 is connected to a liquid pathway channel 1008 that is engraved on, or formed in, the surface 1009 of the cell frame 1000. Channel 1008 is sealed and turned into a liquid pathway pipe or liquid conduit when cell frame 1002 is pressed tightly against cell frame 1000 as shown at the top left of FIG. 10. Cell frame 1000 is flat.

Channel 1008 connects to a miniature porous capillary structure 1010 and miniature dripper 1011 that has been fabricated separately and inserted into cell frame 1000. Liquid electrolyte flowing from the liquid electrolyte inlet header aperture 1007 will pass along the pipe or conduit formed by channel 1008, through porous capillary structure 1010, into dripper 1011. Dripper 1011 will break the incoming liquid stream into droplets interspersed with gas gaps when the liquid flow passes through the dripper 1011 into the gas-filled drip chamber 1012. The purpose of porous capillary structure 1010 is to prevent gas in the gas-filled drip chamber 1012 from moving up through dripper 1011 into channel 1008. That is, the porous capillary structure 1010 has a ‘bubble point’ that is high enough to prevent gas from moving through it into the channel 108. After passing through dripper 1011, liquid droplets will fall to the bottom of the gas-filled drip chamber 1012 and then flow into inlet channel 1013, which deposits the liquid electrolyte in the anolyte chamber formed within the thickness of cut 1005. The anolyte chamber will fill to level 1015, after which excess liquid electrolyte will flow over the overflow weir formed by outlet 1014 into outlet channel 1016. At or near outlet 1014, another porous capillary structure 1141 may be located to prevent gas from above the liquid level 1015 from being drawn into the liquid stream in outlet channel 1016. At the base of outlet channel 1016, there may be another porous capillary structure and dripper (not shown) that will break the liquid flow into droplets interspersed with gas gaps, falling into outlet header aperture 1017. The purpose of the porous capillary structure in this location is to prevent gas from above the liquid level in header 1017 from passing up through the dripper into outlet channel 1016.

To avoid unreliability in the dripping action due to the presence of a small, fixed volume of gas in the drip chamber 1012 (as discussed above), the drip chamber 1012 may incorporate a gas line (conduit) between the drip chamber 1012 and the gas body above the liquid level 1015. While not shown in FIG. 10, such a gas line would provide for gas flow between the gas body above liquid level 1015 and the gas in the drip chamber 1012, thereby preventing or ameliorating pressure fluctuations in the gas volume in drip chamber 1012 that could cause an unreliable dripping action by the dripper 1011.

Within the filter-press arrangement of cells compressed together as shown schematically for cells 1000, 1001, and 1003 at the top left of FIG. 10, each individual cell will therefore be: (i) electrically isolated against shunt currents, and (ii) maintain the liquid anolyte at the level 1015 during operation, provided only that a small excess of liquid electrolyte is continuously supplied to the cell via inlet header aperture 1007.

In the context of the present specification, the above components may be considered to be ‘miniature’ if they have dimensions that fall within the following.
A cell, such as cell 1001, 1002, or 1003, that has a width or thickness of less than 50 mm, less than 6 mm, less than 4 mm, less than 2 mm, less than 1 mm, less than 0.5 mm, less than 0.25 mm, less than 30 mm, less than 20 mm, less than 10 mm, less than 8 mm, or less than 5 mm.
A liquid catholyte outlet or liquid anolyte outlet, such as overflow weir 1014, that has a width, a thickness, or a diameter of less than 50 mm, less than 30 mm, less than 20 mm, less than 10 mm, less than 8 mm, less than 6 mm, less than 4 mm, less than 2 mm, less than 1 mm, less than 0.5 mm, or less than 0.25 mm.
A liquid catholyte or a liquid anolyte inlet, such as channel 1008 or channel 1013, that has a width, a thickness, or a diameter of less than 50 mm, less than 30 mm, less than 20 mm, less than 10 mm, less than 8 mm, less than 6 mm, less than 4 mm, less than 2 mm, less than 1 mm, less than 0.5 mm, or less than 0.25 mm.
A dripper, such as dripper 1011, that has a thickness or a diameter of less than 50 mm, less than 30 mm, less than 20 mm, less than 10 mm, less than 8 mm, less than 6 mm, less than 4 mm, less than 2 mm, less than 1 mm, less than 0.5 mm, or less than 0.25 mm.
A dripper, such as dripper 1011, that has an aperture through which a liquid stream passes and is broken up, wherein the aperture has a diameter of less than 5 mm, less than 3 mm, less than 2 mm, less than 1 mm, less than 0.8 mm, less than 0.6 mm, less than 0.4 mm, less than 0.2 mm, less than 0.1 mm, less than 0.05 mm, or less than 0.025 mm.
A dripper, such as dripper 1011, that produces drops that have a diameter or thickness of less than 5 mm, less than 3 mm, less than 2 mm, less than 1 mm, less than 0.8 mm, less than 0.6 mm, less than 0.4 mm, less than 0.2 mm, less than 0.1 mm, less than 0.05 mm, or less than 0.025 mm.
A drip chamber, such as drip chamber 1012, that has a height of less than 50 mm, less than 30 mm, less than 20 mm, less than 15 mm, less than 12 mm, less than 10 mm, less than 9 mm, less than 8 mm, less than 7 mm, less than 6 mm, less than 5 mm, or less than 3 mm.
A drip chamber, such as drip chamber 1012, that has a diameter or a width of less than 50 mm, less than 30 mm, less than 20 mm, less than 10 mm, less than 8 mm, less than 6 mm, less than 4 mm, less than 2 mm, less than 1 mm, less than 0.5 mm, or less than 0.25 mm.
A porous capillary structure, such as porous capillary structure 1010 or 1141, that has a diameter or a width of less than 50 mm, less than 30 mm, less than 20 mm, less than 10 mm, less than 8 mm, less than 6 mm, less than 4 mm, less than 2 mm, less than 1 mm, less than 0.5 mm, or less than 0.25 mm.

### Ensuring Equal Flow of Electrolyte Through Multiple Cells Stacked in a Cell Stack

Preferably for efficient operation, with the cell arrangements discussed above, equal quantities of liquid should flow through each of the cells that are stacked together in the filter-press arrangement. A typical problem in this regard is that the cell closest to the water inlet of the cell stack may experience a faster rate of liquid passing through it than the cell furthest from the water inlet. This may be because of differences in the pressure change experienced by the liquid in passing through the different cells. That is, the cell in which the liquid passing through experiences the largest pressure drop may experience the largest flow of liquid through it.

One way to overcome this issue is shown in FIG. 11, which depicts in schematic form, cell stack 1100 including three cells being first cell 1101, second cell 1102, and third cell 1103 in a filter-press-type cell stack. Three cells are shown for illustrative purposes and is not limiting, various examples can have different numbers of cells in a cell stack. In the arrangement depicted in FIG. 11, the upper liquid inlet header 1107 is pressurised to a higher pressure than the liquid in each of first cell 1101, second cell 1102, and third cell 1103, while the pressure of the lower liquid outlet header 1108 is lower than the pressure in each cell. The effect of such an arrangement is that each cell 1101, 1102, and 1103 in the cell stack 1100 is induced to have an equal or substantially equal quantity of liquid passing through it since the pressure drop experienced by the liquid passing through each cell is substantially the same. That is, the arrangement depicted in FIG. 11 minimizes differences the pressure drop experienced by liquid passing through each of the cells.

Considering FIG. 11 in detail: the liquid in the upper liquid inlet header 1107 is pressurised to a higher pressure than the pressure within each cell itself (i.e. first cell 1101, second cell 1102, and third cell 1103) and is higher than within the lower liquid outlet header 1108. The liquid inlet channel to each cell (first cell 1101, second cell 1102, and third cell 1103) also may be patterned into a restrictor 1104 (which involves a very thin channel, with many sharp bends). Structure 91 in FIG. 8 depicts an example of a restrictor. A restrictor has the effect of creating a pressure drop in the liquid passing through it. For example, the liquid passing through the restrictor in FIG. 11 goes from having a higher pressure in the upper liquid inlet header 1107 to the lower pressure of the cell.

After passing through the restrictor 1104, the liquid is then passed through a porous capillary structure and dripper 1105 causing the liquid stream to break up into a series of drops, droplets, slugs, or portions of liquid interspersed with gas gaps, for example air gaps. The effect of the dripper 1105 is to break electrical conduction between the liquid in the cell (e.g. the liquid below cell liquid level 1109) (level 1015 in FIG. 10) and the liquid in the header (e.g. the liquid in upper liquid inlet header 1107 (formed by header 1007 in FIG. 10).

After entering the cell and helping maintain a cell liquid level 1109 in the cell, excess liquid flows over an outlet weir into the liquid outlet channel (e.g. outlet weir 1016 in FIG. 10). Thereafter, the liquid in the liquid outlet channel may be passed through a second restrictor (not shown in FIG. 11) and second dripper 1106 (with associated porous capillary structure) into the lower liquid outlet header 1108 (e.g. header 1017 in FIG. 10). The lower liquid outlet header 1108 (e.g. 1017 in FIG. 10) is pressurised to a lower pressure than the cell pressure.

The effect of the arrangement of the cell stack 1100 depicted in FIG. 11 is that, since the upper liquid supply header 1107 (e.g. header 1007 in FIG. 10) is pressurised to a higher pressure than the liquid in the cell 1101 (e.g. the liquid below level 1015 in FIG. 10), an equal or substantially equal quantity of liquid passes through each of the first drippers 1105 in cells 1101, 1102, and 1103 per unit time. Similarly, as the pressure inside the cells 1101, 1102, 1103 (e.g. the liquid below level 1015 in FIG. 10) is higher than the pressure in the lower liquid outlet header 1108 (e.g. header 1017 in FIG. 10), an equal or substantially equal quantity of liquid passes through each of the lower drippers 1106 in cells 1101, 1102, and 1103 per unit time.

By these means, a stack of very thin cells in a filter-press arrangement can be reliably made to maintain a pre-determined level of liquid electrolyte during operation without the need for electronic or mechanical level sensors, whilst simultaneously avoiding shunt currents.

### Electrolytes

While the above examples have used aqueous 6 M KOH as the liquid electrolyte, a wide range of other liquids may be employed as electrolyte, including but not limited to:
water containing one or more dissolved ions, such as, but not limited to: 0.001-14 M concentrations of Na⁺, K⁺, Ca²⁺, Mg²⁺, OH⁻, SO₄²⁻, HSO₄⁻, Cl⁻, NO₃⁻, ClO₄⁻, phosphates (including HPO₄⁻), carbonates (including HCO₃⁻), PF₆⁻, BF₄⁻, (CF₃SO₂)₂N⁻, or polyelectrolytes that contain polymers with functional groups, such as, but not limited to polystyrene sulfonate, DNA, polypeptides;
non-aqueous liquids containing solutes, such as, but not limited to propylene carbonate or dimethoxyethane or propionitrile liquids containing solutes such as, but not limited to, LiClO₄, or Bu₄NPF₆; or
conductive liquids, such as, but not limited to ambient temperature molten salts or ionic liquids comprising of alkyl-substituted ammonium, imidazolium, or pyridinium cations paired with suitable anions.

### Example: Capillary-Based Cells

The following example relates to capillary-based electro-synthetic or electro-energy cells, for example of the types described in International Patent Publication Nos. WO2022056603, WO2022056604, WO2022056605, and WO2022056606, which are hereby incorporated by reference.

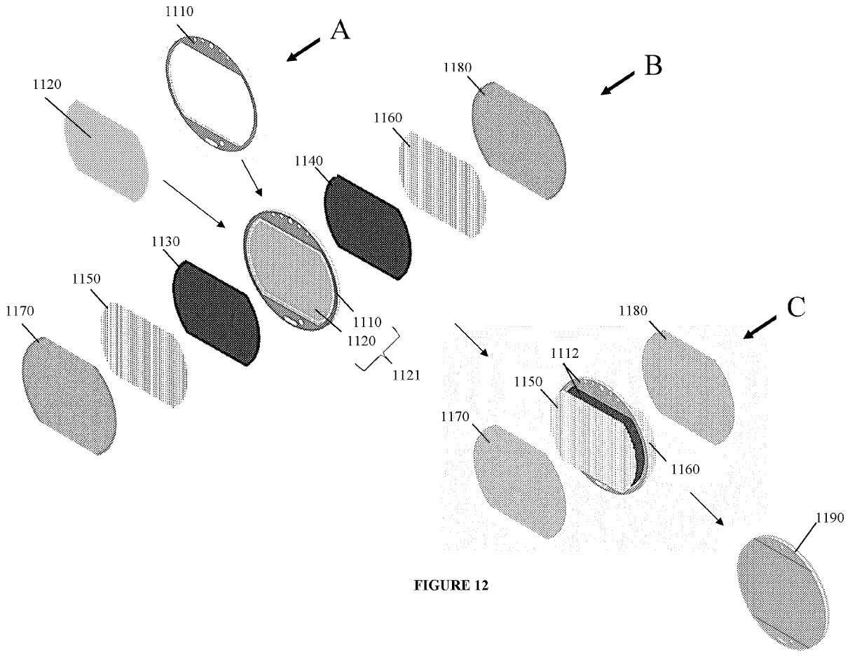

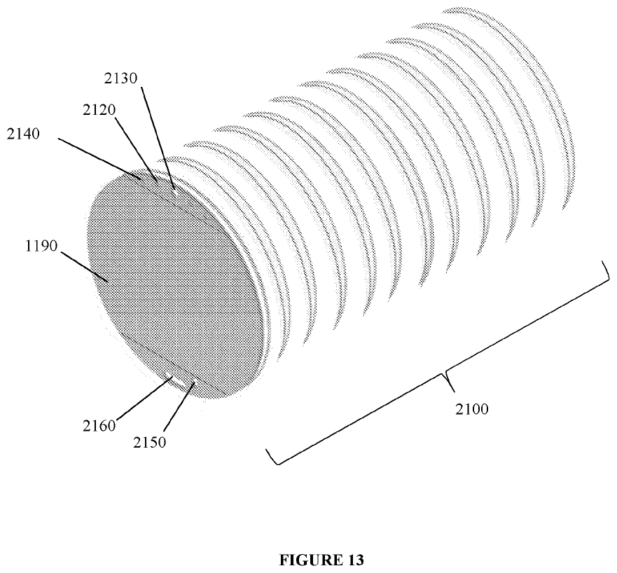

Prior to describing the liquid features in such a capillary-based cell, it is necessary to describe how the cell may be assembled. FIG. 12 schematically depicts how the components of an example preferred embodiment capillary-based electro-synthetic or electro-energy cell 1190 may be assembled.

Starting at the top left of FIG. 12 along row A, the cell comprises of a polymeric cell frame 1110 having a relatively large, open window in its centre (i.e. a window cut-out), and an inter-electrode porous capillary spacer 1120 (also called an inter-electrode porous capillary separator 1120) capable of drawing liquid up by a capillary effect from a reservoir at the base of the cell. Preferably but not exclusively, the base material of the inter-electrode porous capillary spacer 1120 comprises the same or a substantially similar polymeric material to the material of construction of the cell frame 1110

Row B in FIG. 12 shows the inter-electrode porous capillary spacer 1120 welded to the cell frame 1110, forming the assembly 1121. Other elements in the exploded view shown along row B in FIG. 12 include the electrodes 1130 and 1140, which may be porous and comprise a metallic base. The electrodes 1130 and 1140 are pre-cut to fit the window of the cell frame 1110. On the outside of the electrodes are conducting, metallic, compressive (e.g. springed) elements 1150 and 1160 that are also cut to fit the window of cell frame 1110. On the outsides of the exploded view at row B in FIG. 12 are solid metal bipolar plates 1170 and 1180. These have been pre-cut to be larger than the window and overlap the outside of the cell frame 1121, including the top, bottom and side edges of the frame 1110.

Row C in FIG. 12 depicts the next stage in the assembly. The electrodes 1130 and 1140 are placed within the window of cell frame 1121, located tight up against opposite sides of the inter-electrode porous capillary spacer 1120 that has been welded to the cell frame 1110. The assembly of cell frame 1110, inter-electrode porous capillary spacer 1120 and electrodes 1130 and 1140 is labelled as assembly 1112.

As can be seen in the image in row C, the compressive (e.g. springed) elements 1150 and 1160 are about to be inserted into the window of cell frame 1112. Thereafter, the metallic bipolar plates 1170 and 1180 will be securely affixed, for example by ultrasonic or platen welding, to the uncovered, exposed polymer surfaces on its front and the back respectively, at the top, bottom and around the sides of the cell frame 1110, thereby sealing the cell closed. Another effect of affixing the bipolar plates 1170 and 1180 to the cell frame assembly 1112 is that the compressive (e.g. springed) elements 1150 and 1160, located between the bipolar plates 1170 and 1180 and the electrodes 1130 and 1140, will then also exert a clamping force on the electrodes 1130 and 1140 respectively, compressing them tightly against opposite sides of the inter-electrode porous capillary separator 1120.

The image at the bottom right of FIG. 12 depicts the fully assembled cell 1190 which is a flat, thin cell that can be used, for example, in a filter-press cell stack.

As can be seen in FIG. 12:
(1) To the extent that compression of the electrodes 1130 and 1140 against opposite sides of the inter-electrode porous capillary spacer 1120 is required, cell 1190 has been partially or fully compressed by securely affixing the bipolar plates 1170 and 1180 to the uncovered, exposed polymer surfaces on its front and the back respectively, at the top, bottom and around the sides of the cell frame 1110. In so doing, the compressive (e.g. springed) elements 1150 and 1160 were compressed against the electrodes 1130 and 1140 respectively.
(2) To the extent that cell 1190 can be sealed, it has been sealed as fully as is possible at this stage by securely affixing the bipolar plates 1170 and 1180 onto the uncovered, exposed polymer surfaces at the top, bottom and around the sides of the cell frame 1110, on its front and the back respectively.

FIG. 13 schematically depicts how example capillary-based electro-synthetic or electro-energy cells 1190 may be stacked in a cell stack 2100. The header apertures at the top of each cell (e.g. header apertures 2120, 2130, and 2140) and at the bottom of each cell (e.g. header apertures 2150 and 2160), are lined up in the different cells in the stack, so that they effectively form top headers and bottom headers through the cell stack 2100.

In a filter-press type cell stack, headers like that formed by header apertures 2120, 2130, 2140, 2150 and 2160 normally would be sealed to each other by tightly compressing the cells in the stack between two endplates and maintaining such compression thereafter. Compression typically would be needed to ensure that liquids and/or gases in the headers were not able to flow into the spaces between the cells.

Moreover, an electrical current may be applied through the stack, via the electrical series connection of the bipolar plates in the stack. In so doing, the stack would act as a collection of electro-synthetic or electro-energy cells operating in unison.

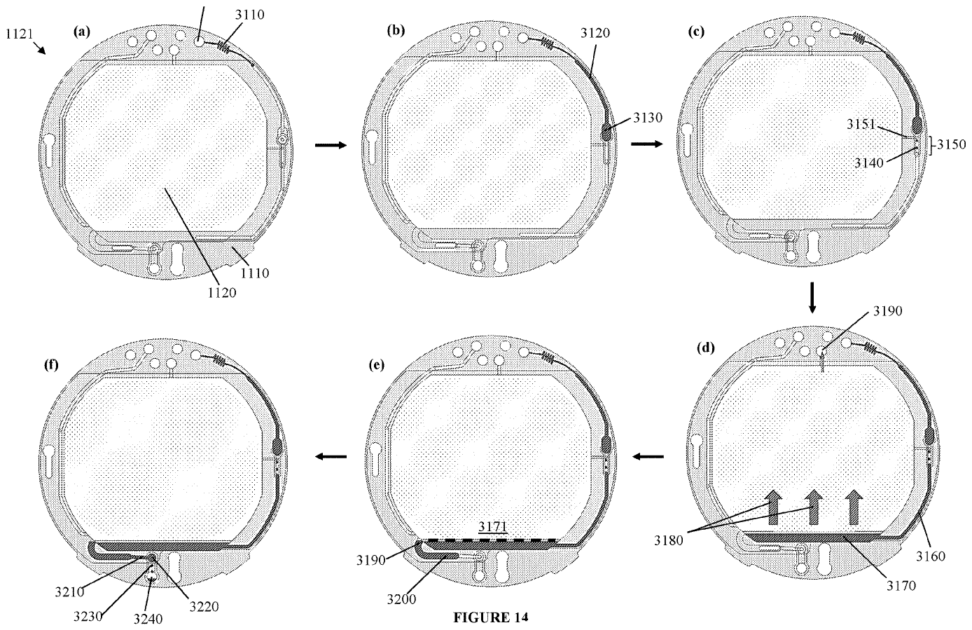

FIG. 14 schematically depicts the liquid features of such a cell 1190. FIG. 14 shows the inter-electrode porous capillary spacer 1120 welded to the cell frame 1110, forming the assembly 1121, of a single cell 1190. The sequence of images in FIG. 14(a) to FIG. 14(f) depicts how liquid electrolyte may pass through such a capillary-fed cell 1190 within such a cell stack 2100. The liquid is shown as the solid filled areas. The cell frame has, in one specific example, an outer diameter of 23 cm, with the features illustrated in proportional sizes.

In FIG. 14(a), liquid passes from the liquid inlet header 3100 into and through a restrictor 3110 that has been injection moulded into the polymeric cell frame.

In FIG. 14(b), the liquid passes out of the restrictor 3110 into a liquid pathway channel 3120 and then into a porous capillary structure 3130 with a dripper below the porous capillary structure.

In FIG. 14(c), the dripper below porous capillary structure 3130 breaks the liquid stream into drops 3140 (i.e. droplets), which fall through a gas-filled drip chamber 3150. The drip chamber has a drip chamber gas line 3151 connecting it to a region in which a larger gas body is present, to thereby maintain the gas atmosphere in the drip chamber and prevent pressure fluctuations in the gas in the gas chamber, which may affect the reliability of the dripping action.

In FIG. 14(d), the drops 3140 coalesce into a homogeneous liquid phase at the bottom of drip chamber 3150 and flow into liquid pathway channel 3160 and then into the base of the cell, where a reservoir 3170 is formed on the front of the porous capillary spacer 1120. The liquid in the reservoir 3170 is drawn up the porous capillary spacer 1120 in the direction 3180, filling the porous capillary spacer 1120 with liquid.

In FIG. 14(e), the height of the reservoir 3171 is set by the height of the overflow weir 3190, over which excess liquid passes into liquid flow channel 3200. A porous capillary structure is incorporated into the mouth of the overflow weir 3190. By this means, the level 3171 of the liquid in the reservoir 3170 is maintained constant.

In FIG. 14(f), the liquid in channel 3200 flows into a porous capillary structure 3210 adjacent to a dripper 3220. The dripper breaks the liquid flow into drops 3230 (i.e. droplets), which fall through a gas-filled drip chamber that is partially comprised on the liquid outlet header 3240.

When the cell operates as an electro-synthetic cell and generates gas in the half-cell shown in FIG. 14, then the gas escapes from the half-cell along the gas channel (arrow) going into the gas header 3190 in FIG. 14(d).

The liquid channels shown along the pathway illustrated in FIG. 14 (a)-(f) may be sealed by stacking multiple such cells in a stack and then compressing them together. Alternatively, they may be sealed by welding covers on them, such as thin polymeric covers.

The liquid and gas features depicted in FIG. 14 may be repeated on the other side of the assembly 1121 for the other half cell. In this way, the level of liquid in a reservoir 3170 at the base of a cell 3190 may be maintained constant whilst simultaneously ensuring that the liquid in the reservoir 3170 is electrically disconnected from the liquid in the reservoirs in other cells 1190 in the stack 2100. Shunt currents are thereby also eliminated.

In further specific examples, there is provided:
(i) a cell with at least one dripper and at least one weir, where the cell is an alkaline water electrolyser or fuel cell, and where the electrolyte is a hydroxide with pH more than 12.
(ii) a cell with at least one dripper and at least one weir, together with an electrode separator of less than 0.2 mm thickness.
(iii) a cell with at least one dripper and at least one weir, and having a compression of the electrodes on the electrode separator of more than 2 bar.
(iv) a cell with at least one dripper and at least one weir, where the cell is an alkaline water electrolyser or fuel cell, and where the electrolyte is a hydroxide with pH more than 12, together with an electrode separator of less than 200 micron thickness.
(v) a cell with at least one dripper and at least one weir, where the cell is an alkaline water electrolyser or fuel cell, and where the electrolyte is a hydroxide with pH more than 12, and having a compression on the electrode separator of more than 2 bar.
(vi) a cell with at least one dripper and at least one weir, where the cell is an alkaline water electrolyser or fuel cell, and where the electrolyte is a hydroxide with pH more than 12, together with an electrode separator of less than 200 micron thickness, and having a compression on the electrode separator of more than 2 bar.

### Electro-Synthetic and Electro-Energy Cells

Optionally, the cell with the above liquid features is an electro-energy cell, such as: (i) a hydrogen-oxygen fuel cell, including a Polymer Electrolyte Membrane (PEM) fuel cell or an Alkaline fuel cell, (ii) a direct alcohol fuel cell, including a direct methanol or direct ethanol fuel cell, (iii) a phosphoric acid fuel cell, or (iv) an ammonia fuel cell.

Optionally, the cell with the above liquid features is an electro-synthetic cell, such as: (i) a water electrolyser, (ii) a chlor-alkali electrolyzer, (iii) a cell for ammonia manufacture, or (iv) a CO₂ electrolyser, including a combined carbon capture and CO₂ electrolyser.

### Combinations of Features

According to various non-limiting example embodiments, the following points disclose combinations of features that provide various example cells, multi-cell stacks, systems and/or example methods of operation.
1. An electro-energy or electro-synthetic cell, comprising:
   a cathode half-cell comprising:
      a cathode;
      a liquid catholyte inlet section having a liquid catholyte inlet for supplying liquid catholyte to the cathode half-cell; and
      a liquid catholyte outlet section having a liquid catholyte outlet for removing liquid catholyte from the cathode half-cell;
   an anode half-cell comprising:
      an anode;
      a liquid anolyte inlet section having a liquid anolyte inlet for supplying liquid anolyte to the anode half-cell; and
      a liquid anolyte outlet section having a liquid anolyte outlet for removing liquid anolyte from the anode half-cell;
   an electrode separator positioned between the cathode and the anode; and
   a dripper positioned in-line in the liquid catholyte inlet section, the liquid catholyte outlet section, the liquid anolyte inlet section or the liquid anolyte outlet section, wherein the dripper breaks the liquid catholyte or the liquid anolyte into drops, and the drops are received in a drip chamber positioned below the dripper, and wherein the drip chamber has a height of less than 50 mm.
2. The electro-energy or electro-synthetic cell of point 1, wherein the drip chamber includes a drip chamber gas line.
3. The electro-energy or electro-synthetic cell of point 1 or 2, wherein the liquid catholyte or the liquid anolyte on one side of the dripper is electrically isolated from the liquid catholyte or the liquid anolyte on the other side of the dripper.
4. The electro-energy or electro-synthetic cell of any of the preceding points, wherein the dripper is at least one of:
   a first dripper is positioned in the liquid catholyte inlet section;
   a second dripper is positioned in the liquid catholyte outlet section;
   a third dripper is positioned in the liquid anolyte inlet section; and/or
   a fourth dripper is positioned in the liquid anolyte outlet section.
5. The electro-energy or electro-synthetic cell of any of the preceding points, wherein the liquid catholyte and the liquid anolyte within the cell is electrically isolated from the liquid catholyte and the liquid anolyte, respectively, outside of the cell.
6. The electro-energy or electro-synthetic cell of any of the preceding points, wherein the dripper breaks the flow of the liquid catholyte or the liquid anolyte into drops interspersed with gas gaps between the drops.
7. The electro-energy or electro-synthetic cell of any of the preceding points, wherein the gas gaps are air gaps.
8. The electro-energy or electro-synthetic cell of any of the preceding points, wherein the gas gaps are non-conducting gas voids.
9. The electro-energy or electro-synthetic cell of any of the preceding points, wherein the gas gaps are provided via the drip chamber gas line.
10. The electro-energy or electro-synthetic cell of any of the preceding points, wherein the liquid catholyte inlet, the liquid catholyte outlet, the liquid anolyte inlet, and the liquid anolyte outlet each have a thickness or a diameter less than 50 mm, less than 30 mm, less than 20 mm, less than 10 mm, less than 8 mm, less than 6 mm, less than 4 mm, less than 2 mm, less than 1 mm, less than 0.5 mm, or less than 0.25 mm.
11. The electro-energy or electro-synthetic cell of any of the preceding points, wherein the dripper has a thickness or a diameter of less than 50 mm, less than 30 mm, less than 20 mm, less than 10 mm, less than 8 mm, less than 6 mm, less than 4 mm, less than 2 mm, less than 1 mm, less than 0.5 mm, or less than 0.25 mm.
12. The electro-energy or electro-synthetic cell of any of the preceding points, wherein the dripper includes an aperture having a diameter less than 5 mm, less than 3 mm, less than 2 mm, less than 1 mm, less than 0.8 mm, less than 0.6 mm, less than 0.4 mm, less than 0.2 mm, less than 0.1 mm, less than 0.05 mm, or less than 0.025 mm.
13. The electro-energy or electro-synthetic cell of any of the preceding points, wherein the drops have a diameter or thickness of less than 5 mm, less than 3 mm, less than 2 mm, less than 1 mm, less than 0.8 mm, less than 0.6 mm, less than 0.4 mm, less than 0.2 mm, less than 0.1 mm, less than 0.05 mm, or less than 0.025 mm.
14. The electro-energy or electro-synthetic cell of any of the preceding points, wherein the drip chamber has a height of less than 30 mm, less than 20 mm, less than 15 mm, less than 12 mm, less than 10 mm, less than 9 mm, less than 8 mm, less than 7 mm, less than 6 mm, less than 5 mm, or less than 3 mm.
15. The electro-energy or electro-synthetic cell of any of the preceding points, wherein the drip chamber has a diameter or a width of less than 50 mm, less than 30 mm, less than 20 mm, less than 10 mm, less than 8 mm, less than 6 mm, less than 4 mm, less than 2 mm, less than 1 mm, less than 0.5 mm, or less than 0.25 mm.
16. The electro-energy or electro-synthetic cell of any of the preceding points, wherein the electrical resistance between the liquid catholyte or the liquid anolyte on one side of the dripper and the liquid catholyte or the liquid anolyte, respectively, on the other side of the dripper is greater than 1Ω, greater than 10Ω, greater than 50Ω, greater than 100Ω, greater than 400Ω, greater than 700Ω, greater than 900Ω, greater than 1 kΩ, greater than 5 kΩ, greater than 10 kΩ, greater than 50 kΩ, greater than 100 kΩ, greater than 1 MΩ, greater than 5 MΩ, greater than 10 MΩ, greater than 50 MΩ, greater than 100 MΩ, or greater than 1,000 MΩ.
17. The electro-energy or electro-synthetic cell of any of the preceding points, wherein a further dripper, and a further drip chamber positioned below the further dripper, are provided in fluid communication with the dripper and the drip chamber.
18. The electro-energy or electro-synthetic cell of any of the preceding points, wherein the further dripper and the further drip chamber are positioned in the liquid catholyte inlet section, the liquid catholyte outlet section, the liquid anolyte inlet section or the liquid anolyte outlet section in-line with the dripper and the drip chamber.
19. The electro-energy or electro-synthetic cell of any of the preceding points, wherein the drip chamber is a slug chamber and the drops are slugs.
20. The electro-energy or electro-synthetic cell of any of the preceding points, wherein the drip chamber gas line is a slug chamber gas line.

21. The electro-energy or electro-synthetic cell of any of the preceding points, further including a restrictor.
22. The electro-energy or electro-synthetic cell of any of the preceding points, wherein the liquid catholyte inlet section, the liquid catholyte outlet section, the liquid anolyte inlet section or the liquid anolyte outlet section include or are in fluid communication with the restrictor that creates a pressure drop in the liquid catholyte or the liquid anolyte passing through the restrictor.
23. The electro-energy or electro-synthetic cell of any of the preceding points, wherein the restrictor is a moulded or machined polymer and includes multiple bends.
24. The electro-energy or electro-synthetic cell of any of the preceding points, wherein the restrictor is positioned above a slug chamber provided with a slug chamber gas line, the slug chamber is positioned above the dripper which is positioned above the drip chamber provided with the drip chamber gas line.
25. The electro-energy or electro-synthetic cell of any of the preceding points, wherein the liquid catholyte outlet and/or the liquid anolyte outlet provide an overflow weir over which excess liquid catholyte and/or excess liquid anolyte flows out of the cell.
26. The electro-energy or electro-synthetic cell of any of the preceding points, wherein the liquid catholyte outlet provides a first overflow weir over which excess liquid catholyte flows out of the cathode half-cell, and wherein the first overflow weir is positioned at a first level being higher in the cathode half-cell than the liquid catholyte inlet.
27. The electro-energy or electro-synthetic cell of any of the preceding points, wherein the liquid anolyte outlet provides a second overflow weir over which excess liquid anolyte flows out of the anode half-cell, and wherein the second overflow weir is positioned at a second level being higher in the anode half-cell than the liquid anolyte inlet.
28. The electro-energy or electro-synthetic cell of any of the preceding points, wherein a level of the liquid catholyte and a level of the liquid anolyte remains substantially constant during operation of the cell.
29. The electro-energy or electro-synthetic cell of any of the preceding points, wherein a porous capillary structure is positioned above the dripper and in-line in the liquid catholyte inlet section, the liquid catholyte outlet section, the liquid anolyte inlet section or the liquid anolyte outlet section.
30. The electro-energy or electro-synthetic cell of any of the preceding points, wherein the dripper incorporates or abuts the porous capillary structure.
31. The electro-energy or electro-synthetic cell of any of the preceding points, further including where the porous capillary structure is at least one of:
   a first porous capillary structure positioned in the catholyte inlet section and positioned above the first dripper;
   a second porous capillary structure positioned in the catholyte outlet section and positioned above the second dripper;
   a third porous capillary structure positioned in the anolyte inlet section and positioned above the third dripper; and/or
   a fourth porous capillary structure positioned in the anolyte outlet section and positioned above the fourth dripper.
32. The electro-energy or electro-synthetic cell of any of the preceding points, wherein the liquid catholyte inlet section, liquid catholyte outlet section, the liquid anolyte inlet section, the liquid anolyte outlet section, the dripper and the drip chamber are formed into one or more frames of the cell.
33. An electro-energy or electro-synthetic cell, comprising:
   a cathode half-cell comprising:
      a cathode;
      a liquid catholyte inlet for supplying liquid catholyte to the cathode half-cell; and
      a liquid catholyte outlet providing a first overflow weir over which excess liquid catholyte flows out of the cathode half-cell;
      wherein the first overflow weir is positioned at a first level being higher in the cathode half-cell than the liquid catholyte inlet;
   an anode half-cell comprising:
      an anode;
      a liquid anolyte inlet for supplying liquid anolyte to the anode half-cell; and
   a liquid anolyte outlet providing a second overflow weir over which excess liquid anolyte flows out of the anode half-cell;
   wherein the second overflow weir is positioned at a second level being higher in the anode half-cell than the liquid anolyte inlet; and
      an electrode separator positioned between the cathode and the anode.
34. The electro-energy or electro-synthetic cell of any of the preceding points, further including a first porous capillary structure positioned at or downstream of the first overflow weir.
35. The electro-energy or electro-synthetic cell of any of the preceding points, further including a second porous capillary structure positioned at or downstream of the second overflow weir.
36. The electro-energy or electro-synthetic cell of any of the preceding points, wherein the liquid catholyte outlet and the liquid anolyte outlet have a diameter of less than 50 mm, less than 30 mm, less than 20 mm, less than 10 mm, less than 8 mm, less than 6 mm, less than 4 mm, less than 2 mm, less than 1 mm, less than 0.5 mm, or less than 0.25 mm.
37. The electro-energy or electro-synthetic cell of any of the preceding points, wherein the first overflow weir sets the first level of the liquid catholyte in the cathode half-cell.
38. The electro-energy or electro-synthetic cell of any of the preceding points, wherein the second overflow weir sets the second level of the liquid anolyte in the anode half-cell.
39. The electro-energy or electro-synthetic cell of any of the preceding points, wherein the first level is higher than the second level.
40. The electro-energy or electro-synthetic cell of any of the preceding points, wherein the first level is lower than the second level.
41. The electro-energy or electro-synthetic cell of any of the preceding points, wherein the first level is equal to the second level.
42. The electro-energy or electro-synthetic cell of any of the preceding points, wherein during operation the liquid catholyte is maintained at the first level and the liquid anolyte is maintained at the second level.
43. The electro-energy or electro-synthetic cell of any of the preceding points, wherein the liquid catholyte inlet, the liquid catholyte outlet, the liquid anolyte inlet and/or the liquid anolyte outlet is in fluid communication with a dripper.
44. The electro-energy or electro-synthetic cell of any of the preceding points, wherein the liquid catholyte inlet is an opening of a liquid catholyte inlet section, the liquid catholyte outlet is an opening of a liquid catholyte outlet section, the liquid anolyte inlet is an opening of a liquid anolyte inlet section, and the liquid anolyte outlet is an opening of a liquid anolyte outlet section.
45. The electro-energy or electro-synthetic cell of any of the preceding points, wherein the dripper is positioned in the liquid catholyte inlet section, the liquid catholyte outlet section, the liquid anolyte inlet section, and/or the liquid anolyte outlet section.
46. The electro-energy or electro-synthetic cell of any of the preceding points, wherein the dripper breaks a stream of the liquid catholyte or the liquid anolyte into drops that are received in a drip chamber positioned below the dripper.
47. The electro-energy or electro-synthetic cell of any of the preceding points, wherein the drip chamber includes a drip chamber gas line.
48. The electro-energy or electro-synthetic cell of any of the preceding points, wherein:
   the liquid catholyte inlet is in fluid communication with a first dripper;
   the liquid catholyte outlet is in fluid communication with a second dripper; the liquid anolyte inlet is in fluid communication with a third dripper; and/or
   the liquid anolyte outlet is in fluid communication with a fourth dripper.
49. The electro-energy or electro-synthetic cell of any of the preceding points, wherein:
   a first dripper is positioned in the liquid catholyte inlet section;
   a second dripper is positioned in the liquid catholyte outlet section;
   a third dripper is positioned in the liquid anolyte inlet section; and/or
   a fourth dripper is positioned in the liquid anolyte outlet section.
50. The electro-energy or electro-synthetic cell of any of the preceding points, wherein the liquid catholyte or the liquid anolyte on one side of the dripper is electrically isolated from the liquid catholyte or the liquid anolyte on the other side of the dripper.
51. The electro-energy or electro-synthetic cell of any of the preceding points, wherein the liquid catholyte and the liquid anolyte within the cell is electrically isolated from the liquid catholyte and the liquid anolyte, respectively, outside of the cell.
52. The electro-energy or electro-synthetic cell of any of the preceding points, wherein the liquid catholyte inlet section, the liquid catholyte outlet section, the liquid anolyte inlet section and/or the liquid anolyte outlet section include or are in fluid communication with a restrictor that creates a pressure drop in the liquid catholyte or the liquid anolyte passing through the restrictor.
53. The electro-energy or electro-synthetic cell of any of the preceding points, wherein the restrictor is a moulded or machined polymer and includes multiple bends.
54. The electro-energy or electro-synthetic cell of any of the preceding points, wherein the restrictor is positioned upstream of the dripper.
55. A stack of electro-energy or electro-synthetic cells, comprising:
   a plurality of the electro-energy or electro-synthetic cells of any of the preceding points;
56. The stack of electro-energy or electro-synthetic cells of point 55, wherein the stack is formed in a filter-press arrangement.
57. The stack of electro-energy or electro-synthetic cells of points 55 or 56, including a header in fluid communication with each cell in the stack.
58. The stack of electro-energy or electro-synthetic cells of any of the preceding points 55 to 57, wherein the liquid catholyte or the liquid anolyte in the header is pressurised to a higher pressure than the liquid catholyte or the liquid anolyte, respectively, in each cell.
59. The stack of electro-energy or electro-synthetic cells of any of the preceding points 55 to 58, wherein a cell of the stack is formed using a cell frame that is flat.
60. The stack of electro-energy or electro-synthetic cells of any of the preceding points 55 to 59, wherein the cell frame has a thickness of less than 50 mm, less than 30 mm, less than 20 mm, less than 10 mm, less than 8 mm, less than 6 mm, less than 4 mm, less than 2 mm, less than 1 mm, less than 0.5 mm, or less than 0.25 mm.
61. The stack of electro-energy or electro-synthetic cells of any of the preceding points 55 to 60, wherein the liquid catholyte and the liquid anolyte within one cell of the stack is electrically isolated from the liquid catholyte and the liquid anolyte, respectively, in an adjacent cell of the stack.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

Optional embodiments may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that many modifications, changes, substitutions or alterations will be apparent to those skilled in the art without departing from the scope of the present invention.

1. An electro-energy or electro-synthetic cell, comprising:
a cathode half-cell comprising:
a cathode;
a liquid catholyte inlet section having a liquid catholyte inlet for supplying liquid catholyte to the cathode half-cell; and
a liquid catholyte outlet section having a liquid catholyte outlet for removing liquid catholyte from the cathode half-cell;
an anode half-cell comprising:
an anode;
a liquid anolyte inlet section having a liquid anolyte inlet for supplying liquid anolyte to the anode half-cell; and
a liquid anolyte outlet section having a liquid anolyte outlet for removing liquid anolyte from the anode half-cell;
an electrode separator positioned between the cathode and the anode; and
a dripper positioned in-line in the liquid catholyte inlet section, the liquid catholyte outlet section, the liquid anolyte inlet section or the liquid anolyte outlet section,
wherein the dripper breaks the liquid catholyte or the liquid anolyte into drops, and the drops are received in a drip chamber positioned below the dripper, wherein the liquid catholyte or the liquid anolyte on one side of the dripper is electrically isolated from the liquid catholyte or the liquid anolyte on the other side of the dripper, and wherein the drip chamber has a height of less than 50 mm.

2. The electro-energy or electro-synthetic cell of claim 1, wherein the drip chamber includes a drip chamber gas line.

3. The electro-energy or electro-synthetic cell of claim 1, wherein the dripper is at least one of:
a first dripper is positioned in the liquid catholyte inlet section;
a second dripper is positioned in the liquid catholyte outlet section;
a third dripper is positioned in the liquid anolyte inlet section; and/or
a fourth dripper is positioned in the liquid anolyte outlet section.

4. The electro-energy or electro-synthetic cell of claim 3, wherein the liquid catholyte and the liquid anolyte within the cell is electrically isolated from the liquid catholyte and the liquid anolyte, respectively, outside of the cell.

5. The electro-energy or electro-synthetic cell of claim 1, wherein the dripper breaks a flow of the liquid catholyte or the liquid anolyte into drops interspersed with gas gaps between the drops.

6-7. (canceled)

8. The electro-energy or electro-synthetic cell of claim 5, wherein the gas gaps are provided via the drip chamber gas line.

9-17. (canceled)

18. The electro-energy or electro-synthetic cell of claim 1, wherein the drip chamber is a slug chamber and the drops are slugs.

19. The electro-energy or electro-synthetic cell of claim 2, wherein the drip chamber gas line is a slug chamber gas line.

20. The electro-energy or electro-synthetic cell of claim 1, further including a restrictor.

21. (canceled)

22. The electro-energy or electro-synthetic cell of claim 20, wherein the restrictor is a moulded or machined polymer and includes multiple bends.

23. The electro-energy or electro-synthetic cell of claim 20, wherein the restrictor is positioned above a slug chamber provided with a slug chamber gas line, the slug chamber is positioned above the dripper which is positioned above the drip chamber provided with the drip chamber gas line.

24. (canceled)

25. The electro-energy or electro-synthetic cell of claim 1, wherein the liquid catholyte outlet provides a first overflow weir over which excess liquid catholyte flows out of the cathode half-cell, and wherein the first overflow weir is positioned at a first level being higher in the cathode half-cell than the liquid catholyte inlet, and wherein the liquid anolyte outlet provides a second overflow weir over which excess liquid anolyte flows out of the anode half-cell, and wherein the second overflow weir is positioned at a second level being higher in the anode half-cell than the liquid anolyte inlet.

26. (canceled)

27. The electro-energy or electro-synthetic cell of claim 25, wherein a level of the liquid catholyte and a level of the liquid anolyte remains substantially constant during operation of the cell.

28. The electro-energy or electro-synthetic cell of claim 1, wherein a porous capillary structure is positioned above the dripper and in-line in the liquid catholyte inlet section, the liquid catholyte outlet section, the liquid anolyte inlet section or the liquid anolyte outlet section.

29. The electro-energy or electro-synthetic cell of claim 28, wherein the dripper incorporates or abuts the porous capillary structure.

30. The electro-energy or electro-synthetic cell of claim 28, further including where the porous capillary structure is at least one of:
a first porous capillary structure positioned in the catholyte inlet section and positioned above the first dripper;
a second porous capillary structure positioned in the catholyte outlet section and positioned above the second dripper;
a third porous capillary structure positioned in the anolyte inlet section and positioned above the third dripper; and/or
a fourth porous capillary structure positioned in the anolyte outlet section and positioned above the fourth dripper.

31-53. (canceled)

54. A stack of electro-energy or electro-synthetic cells, comprising:
a plurality of the electro-energy or electro-synthetic cells of claim 1, and wherein the stack is formed in a filter-press arrangement.

55. (canceled)

56. The stack of electro-energy or electro-synthetic cells of claim 54, including a header in fluid communication with each cell in the stack.

57. The stack of electro-energy or electro-synthetic cells of claim 56, wherein the liquid catholyte or the liquid anolyte in the header is pressurised to a higher pressure than the liquid catholyte or the liquid anolyte, respectively, in each cell.

58-59. (canceled)

60. The stack of electro-energy or electro-synthetic cells of claim 54, wherein the liquid catholyte and the liquid anolyte within one cell of the stack is electrically isolated from the liquid catholyte and the liquid anolyte, respectively, in an adjacent cell of the stack.
